(19) United States
(12) Patent Application Publication
(10) Pub. No.: US 2008/0110168 A1
(43) Pub. Date: May 15, 2008

(54) Dynamic Fluid Energy Conversion System and Method of Use

(76) Inventor: Fernando Gracia Lopez, Garza Garcia (MX)

Correspondence Address: FISH & RICHARDSON P.C., P.O. BOX 1022, MINNEAPOLIS, MN, 55440-1022, US

(21) Appl. No.: 11/929,138

(22) Filed: Oct. 30, 2007

Related U.S. Application Data
(60) Provisional application No. 60/864,560, filed on Nov. 6, 2006.
(60) Provisional application No. 60/877,973, filed on Dec. 28, 2006.
(60) Provisional application No. 60/977,006, filed on Oct. 2, 2007.

(51) Int. Cl. F03B 17/02; F03B 17/04

(52) U.S. Cl. 60/497; 415/7; 415/916

(57) ABSTRACT

Systems and processes for harnessing the dynamic energy of a fluid body may be used to generate electric power. In particular implementations, a system and process for harnessing the dynamic energy of a fluid body include the ability to follow a movement of a fluid body and pressurize a volume of fluid due to following the movement. The pressurized volume of fluid may be used, at least in part, to drive an electrical generator.

### CROSS-REFERENCE TO RELATED APPLICATIONS

This application claims the benefit of U.S. Provisional Application No. 60/864,560, filed Nov. 6, 2006; U.S. Provisional Application No. 60/877,973, filed Dec. 28, 2006; and U.S. Provisional Application No. 60/977,006, filed Oct. 2, 2007, each of which is incorporated herein by reference in its entirety.

### TECHNICAL FIELD

The present disclosure relates to harnessing dynamic energy of a fluid body and, more particularly, to systems, processes, and techniques for converting dynamic action of a fluid body into a fluid pressurization action, which may be used to generate electrical power.

### BACKGROUND

The world's population has steadily continued to demand more energy for social and economic development. Moreover, the world's population has continued to increase. Thus, the need for energy has continued to expand.

Many traditional techniques for producing energy (e.g., combusting coal and natural gas) have become increasingly expensive with increased energy demand. Also, these techniques, as well as alternative techniques (e.g., nuclear), have numerous environmental drawbacks. Other traditional techniques (e.g., hydroelectric and wind) have not been able to keep pace with demand.

### SUMMARY

This disclosure relates to harnessing the dynamic energy of a fluid body to, for example, produce electric power. In particular, the motion of a fluid body may be used to pressurize (e.g., pump) a pumping fluid to drive an electric generator.

In one general aspect, a system for utilizing movements of a fluid body for generating electric power may include a first pumping mechanism. The first pumping mechanism may include a moveable member, a fluid pump, and a housing. The moveable member may be adapted to follow movements of a fluid body, and the fluid pump may be coupled to the moveable member and adapted to pressurize a pumping fluid in response to motion of the moveable member. The housing may include an inner chamber in which the fluid pump resides and from which the fluid pump draws the fluid to be pressurized.

In particular implementations, the chamber may serve as a reservoir for the pumping fluid. The fluid pumping mechanism may be at least partially immersed in the pumping fluid.

The moveable member may include an elongated member and a buoyant member. The buoyant member may be pivotably coupled to the elongated member proximate an end of the elongated member and adapted to follow fluid body movements. The buoyant member may include a fin adapted to align the buoyant member with fluid body movements.

Certain implementations may include a sensor adapted to detect contamination of the pumping fluid and a valve system coupled to the sensor. The sensor may activate the valve system when contamination of the pumping fluid is detected. The valve system may, for example, circulate the pressurized pumping fluid to the chamber when activated.

The fluid pump may include a tank having a moveable piston housed therein. At least one fluid inlet conduit may be coupled to the tank, and a first one-way valve may be attached to the at least one fluid inlet conduit. At least one fluid outlet conduit may be coupled to the pumping tank, and a second one-way valve may be attached to the at least one fluid outlet conduit.

Particular implementations may include a power transmission mechanism adapted to convey power from the moveable member to the fluid pump. The power transmission mechanism may include a pivoting mechanism coupled between the moveable member and the fluid pump. In certain implementations, the power transmission mechanism may include a pinion gear coupled to the pivoting mechanism and a rack gear coupled to the fluid pumping mechanism, wherein the pinion gear and the rack gear engage each other.

The fluid pump may include a plurality of pumping cylinders adapted to pump the pumping fluid and a rotatable cam adapted to drive the cylinders in response to the moveable member following fluid body movements. The pumping cylinders may form a plurality of axial rows arranged radially circumjacent to the cam, with the cam being rotatable relative to the plurality of pumping cylinders and inward-facing ends of the cylinders adapted to follow the outer surface of the cam. At least one first check valve may be provided upstream of inlets of the pumping cylinders, and at least one second check valve may be provided downstream of outlets of the pumping cylinders. A first axial row of pumping cylinders may intake a volume of pumping fluid while a second axial rows of pumping cylinders simultaneously expels a volume of pumping fluid as the cam rotates.

The system may also include a second pumping mechanism. The second fluid pumping mechanism may include a moveable member adapted to follow movements of a fluid body, a fluid pump coupled to the moveable member and adapted to pressurize a pumping fluid in response to motion of the moveable member, and a housing including an inner chamber in which the fluid pumping mechanism resides and from which the fluid pumping mechanism draws the fluid to be pressurized. A conduit system may combine the pressurized pumping fluid from the first pumping mechanism and the second pumping mechanism.

In certain implementations, the second fluid pumping mechanism may cease supplying pressurized pumping fluid while the first pumping mechanism continues to supply pressurized pumping fluid. The second pumping mechanism may, for example, be replaced while the first pumping mechanism continues to supply pressurized pumping fluid.

In another general aspect, a system for utilizing movements of a fluid body to pressurize a pumping fluid for generating electrical power may include a first pumping mechanism positioned in a fluid body. The pumping mechanism may include a moveable member, a fluid pump, and a housing. The moveable member may be adapted to follow movements of the fluid body, and the fluid pump may be coupled to the moveable member and adapted to pressurize a pumping fluid in response to motion of the moveable member. The housing may include an inner chamber enclosing the fluid pump, a fluid outlet for conveying the pressurized pumping fluid, and a fluid inlet for receiving the pumping fluid. The system may also include a rotatable member positioned on a shore of the fluid body and a power generator. The rotatable member may be coupled to a first conduit system that conveys the pressurized pumping fluid from the pumping mechanism and a second conduit system that conveys the pumping fluid back to the pumping mechanism. The power generator may be coupled to, and driven by, the rotatable member.

In certain implementations, the chamber of the housing acts as a reservoir for the pumping fluid. The fluid pump may be at least partially immersed in the pumping fluid.

The system may also include a sensor and a valve system. The sensor may be adapted to detect contamination of the pumping fluid, and the valve system may be coupled to the sensor. The valve system may circulate the pressurized pumping fluid to the chamber when activated by the sensor detecting contamination in the pumping fluid.

In particular implementations, the fluid pump may include a plurality of pumping cylinders adapted to pump the pumping fluid, and a rotatable cam adapted to drive the cylinders. The cam may drive the pumping cylinders in response to the moveable member following fluid body movements.

The system may additionally include a second pumping mechanism. The second pumping mechanism may also be positioned in the fluid body and include a moveable member adapted to follow movements of the fluid body, a fluid pump coupled to the moveable member and adapted to pressurize a pumping fluid in response to motion of the moveable member, a housing including an inner chamber enclosing the fluid pump, a fluid outlet for conveying the pressurized pumping fluid, and a fluid inlet for receiving the pumping fluid. A first conduit system may combine the pressurized pumping fluid from the first pumping mechanism and the second pumping mechanism for driving the rotatable member.

The second pumping mechanism may cease pumping pressurized pumping fluid while the first pumping mechanism continues to supply the pressurized pumping fluid. For example, the second pumping mechanism may be replaced while the first pumping mechanism continues to supply the pressurized pumping fluid.

The system may also include a bypass conduit in communication with the first conduit system and the second conduit system. A bypass valve may be coupled to the bypass conduit and allow flow of the pressurized pumping fluid between the first and second conduit systems when a predetermined pressure of the pumping fluid is detected.

In particular aspects, a system for utilizing movements of a fluid body to generate electrical power may include a number of pumping mechanisms positioned in a fluid body at various distances from a shore of the fluid body. Each pumping mechanism may include a moveable member having an elongated member and a buoyant member. The buoyant member may be pivotably coupled to the elongated member proximate an end of the elongated member and adapted to follow movements of the fluid body. The buoyant member may also include a fin adapted to align the buoyant member with the fluid body movements. Each pumping mechanism may also include fluid pump, a power transmission mechanism, and a housing. The fluid pump may be coupled to the moveable member and adapted to pressurize a pumping fluid in response to motion of the moveable member. The power transmission mechanism may be adapted to convey power from the moveable member to the pumping mechanism. The housing may include an inner chamber that serves as a reservoir from which the fluid pump draws the pumping fluid to be pressurized and encloses the fluid pump. The fluid pump may be at least partially immersed in the pumping fluid, and the housing may include a fluid outlet for conveying the pressurized pumping fluid and a fluid inlet for receiving the pumping fluid. The pumping mechanisms may further include a sensor adapted to detect contamination of the pumping fluid and a valve system coupled to the sensor. The valve system may be adapted to circulate the pressurized pumping fluid to the chamber when activated by the sensor detecting contamination in the pumping fluid. The system may also include a rotatable member and a power generator. The rotatable member may be positioned on the shore of the fluid body and coupled to a first conduit system that conveys the pressurized pumping fluid from the pumping mechanisms and a second conduit system that conveys the pumping fluid back to the pumping mechanisms. The power generator may be coupled to, and driven by, the rotatable member. At least one of the pumping mechanisms may be shut-down and replaced while the other pumping stations continue to supply pressurized pumping fluid. A bypass conduit may be coupled between the first and second conduit systems, and a bypass valve may be coupled to the bypass conduit. The bypass valve may be adapted to allow flow of the pressurized pumping fluid between the first and second conduit systems when a predetermined pressure of the pumping fluid is detected.

In another general aspect, a process for utilizing movements of a fluid body to pressurize a fluid for generating electrical power may include pressurizing a pumping fluid in a reservoir in response to movements of a fluid body, conveying the pressurized pumping fluid to a rotatable member for a power generator located on a shore of the fluid body, and conveying the pumping fluid to the reservoir. Pressurizing a pumping fluid may, for example, include following movements of the fluid body with a moveable element adapted to follow movements of a fluid body and articulating a pumping mechanism coupled to the moveable element. The reservoir may contain a pumping mechanism, and the pumping mechanism may be at least partially immersed in the pumping fluid in the reservoir.

The process may also include conveying power from the moveable element to the fluid pump. Additionally, the process may include sensing for contamination of the pumping fluid and activating a valve system if contamination of the pumping fluid is detected. The valve system may circulate the pressurized pumping fluid to the reservoir when activated.

Pressurizing a pumping fluid in a reservoir in response to movements of a fluid body may include drawing the pumping fluid into a fluid inlet of a tank, the fluid inlet having a first one-way valve, moving a piston housed in the tank to pressurize the pumping fluid, and expelling the pressurized pumping fluid through a fluid outlet having a second one-way valve. Pressurizing a pumping fluid in a reservoir in response to movements of a fluid body may also include driving a rotatable cam having a plurality of pumping cylinders around its radial periphery.

The process may additionally include pressurizing a second pumping fluid in a second reservoir in response to movements of the fluid body, conveying the pressurized second pumping fluid to a rotatable member, and conveying the second pumping fluid to the second reservoir. Conveying the first pumping fluid to the first reservoir may include conveying at least part of the first pumping fluid to the first reservoir. The process may further include combining the pressurized first pumping fluid and the pressurized second pumping fluid prior to conveying the pressurized first pumping fluid and the pressurized second pumping fluid to the rotatable member, wherein the first rotatable member and the second rotatable member are the same.

The process may also include ceasing to convey the pressurized second pumping fluid while continuing to convey the pressurized first pumping fluid. A second pumping mechanism supplying the pressurized second pumping fluid may be replaced while a first pumping mechanism supplying the pressurized first pumping fluid continues to supply the pressurized first pumping fluid.

Various implementations may include one or more features. For example, as opposed to generating electrical power through burning fossil fuels (e.g., coal), electric power may be generated through using a renewable energy source with minimal air pollution. Thus, the energy source may be used almost indefinitely and have a small effect on air quality. As another example, the energy source may be found at a variety of locations in a variety of countries. Thus, the power generation may be scaled as needed and may have widespread use. As a further example, the mechanisms used to implement the disclosed systems and techniques may have expanded life cycles due to enhanced lubrication and protection. Additionally, conditions that may indicate and/or cause adverse environmental conditions may be monitored and, if detected, contained.

The details of one or more implementations are set forth in the accompanying drawings and the description below. Other features will be apparent from the description and drawings, and from the claims.

### DESCRIPTION OF DRAWINGS

FIG. 1 is a perspective view of an example power generation system;

FIG. 2 is a perspective view of a plurality of pumping mechanisms of FIG. 1;

FIG. 3 is a side view of the pumping mechanisms of FIG. 1;

FIG. 4 is a detail view of a buoy of the pumping mechanism of FIG. 1;

FIG. 5 is a detail view of an example internal structure for a buoy;

FIG. 6 is a perspective view of an example pumping mechanism;

FIG. 7 is a side view of the pumping mechanism of FIG. 6;

FIG. 8 is a perspective view of another example pumping mechanism shown with part of the housing removed;

FIG. 9 shows a side view of the pumping mechanism of FIG. 8;

FIG. 10 is a side view of an example pumping mechanism;

FIG. 11 shows the pumping mechanism of FIG. 10, wherein portions of an outer casing are removed;

FIG. 12 is a perspective view of a pumping mechanism of FIG. 10;

FIG. 13 is a detail view of a shaft for articulating a pumping mechanism according to an example implementation;

FIG. 14 is a partial detail view of an example pumping mechanism;

FIG. 15 shows a detail view of some internal components of the pumping mechanism of FIG. 14;

FIG. 16 shows a further detail view of the internal components of the pumping mechanism of FIG. 14;

FIG. 17 is a detail view illustrating internal workings of an example pumping mechanism;

FIG. 18 shows another detail view of the internal workings of the pumping mechanism of FIG. 17;

FIG. 19 shows lower portions and corresponding pistons of a row of pumping cylinders;

FIG. 20 is a partial detail view of a further example pumping mechanism;

FIG. 21 is a detail view of some internal components of the pumping mechanism of FIG. 20;

FIG. 22 is an another detail view of some internal components of the pumping mechanism of FIG. 20;

FIG. 23 is a detail view illustrating some internal workings of the pumping mechanism of FIG. 20;

FIG. 24 is another detail view illustrating some internal workings of the pumping mechanism of FIG. 20;

FIG. 25 shows a row of pumping cylinders and associated inlet manifold and outlet conduit;

FIG. 26 shows lower portions and corresponding pistons of a row of pumping cylinders;

FIG. 27 shows internal components of another example pumping mechanism;

FIG. 28 is a detail view of a portion of the internal components of the pumping mechanism of FIG. 27, including a closed valve in a bypass conduit;

FIG. 29 is another detail view of the portion of the internal components of the pumping mechanism of FIG. 27 in which the valve is in an open position;

FIG. 30 shows a detail view of the valve in the bypass conduit in the closed position;

FIG. 31 shows a detail view of the valve in the bypass conduit in the closed position;

FIG. 32 is a perspective view of another example power generation system;

FIG. 33 is another perspective view of the power generation system of FIG. 32;

FIG. 34 shows a cross sectional views of a valve in an open position;

FIG. 35 shows a cross sectional view of the valve of FIG. 34 in a closed position;

FIG. 36 shows a perspective view of another example of a power generation system;

FIG. 37 shows another perspective view of the power generation system of FIG. 36;

FIG. 38 is a perspective view of another example pumping mechanism;

FIG. 39 is a perspective view of the pumping mechanism shown in FIG. 38 with a lid removed;

FIG. 40 is a cross-sectional view of the pumping mechanism of FIG. 38, wherein an arm is shown in an upwardly deflected position;

FIG. 41 is a cross-sectional view of the pumping mechanism of FIG. 38, wherein the arm is shown in a downwardly deflected position;

FIG. 42 is a detail view of internal components of the pumping mechanism of FIG. 38;

FIG. 43 is another detail view of the internal components of the pumping mechanism of FIG. 38;

FIG. 44 shows an example sealed bearing of the pumping mechanism of FIG. 38;

FIG. 45 shows an example shaft rotatable within the sealed bearing of FIG. 44;

FIG. 46 shows a pinion gear adaptable to be attached to an end of a shaft;

FIG. 47 shows a rack gear extending from an end of a pumping tank;

FIG. 48 shows a pumping tank of an example pumping mechanism;

FIG. 49 shows a base and a lid of an example pumping mechanism;

FIGS. 50 and 51 are cross-sectional views of the base showing a chamber for housing a volume of fluid and some components of a pumping mechanism;

FIG. 52 is a perspective view of the base of the pumping mechanism of FIG. 38 having a fluid inlet and a fluid outlet extending from the base;

FIG. 53 is a detail view of the tank with the rack gear extending therefrom along with a piping arrangement of an example pumping mechanism;

FIG. 54 is a detail view of a buoy of an example pumping mechanism;

FIG. 55 is a cross-sectional view of the buoy illustrating the internal structure of the buoy;

FIG. 56 shows an assembly of the buoy, arm, sealed bearing, rotatable shaft, and pinion gear of an example pumping mechanism;

FIG. 57 is a partial detail view of an example tank; and

FIG. 58 is a flowchart for a method of generating power.

### DETAILED DESCRIPTION

The dynamic energy of a body of fluid may be harnessed by various systems and techniques to produce useful work, such as producing electrical power. In particular implementations, systems and techniques for converting dynamic energy of a fluid body into electrical power include the capability to pressurize a pumping fluid using the dynamic energy and drive a turbine using the pressurized fluid. Other systems and techniques are possible, however.

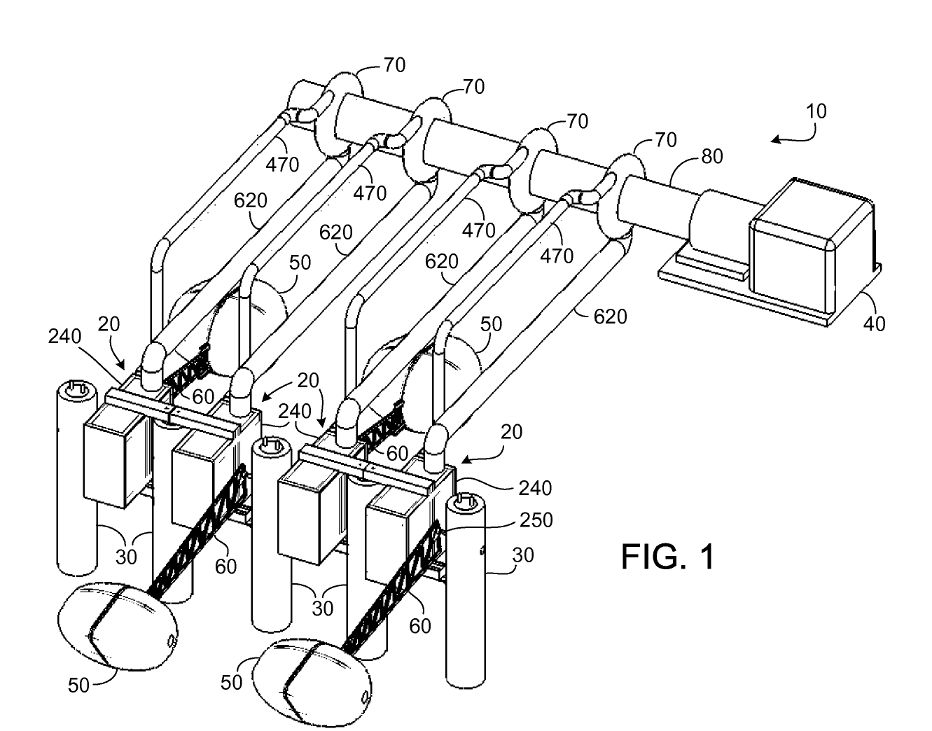

FIG. 1 shows one example of a power generation system 10 for converting fluid energy to electrical power. The system 10 includes one or more fluid pumping mechanisms (“pumping mechanisms”) 20 supported on pilings 30 and coupled to a power generator 40. The pumping mechanisms 20 include a buoy 50 and an arm 60 and pressurize (e.g., pump) a pumping fluid, such as a hydraulic oil. Each arm 60 defines at least part of an elongated member, and each buoy 50 defines at least part of a buoyant member. Together, a buoy 50 and an arm 60 define at least a portion of a moveable member of a pumping mechanism 20 for following a movement of a fluid body. The pressurized pumping fluid rotates one or more turbines 70 attached to a shaft 80 of the generator 40.

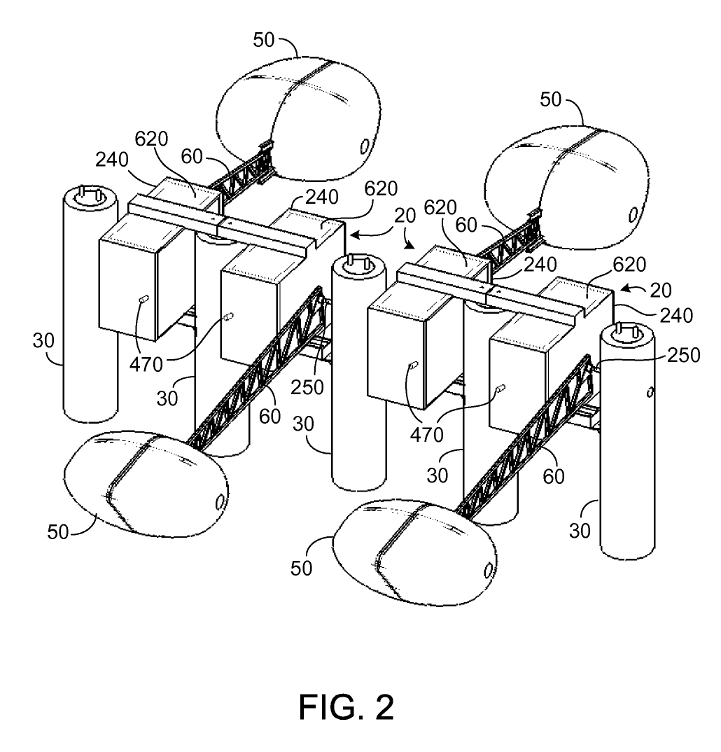

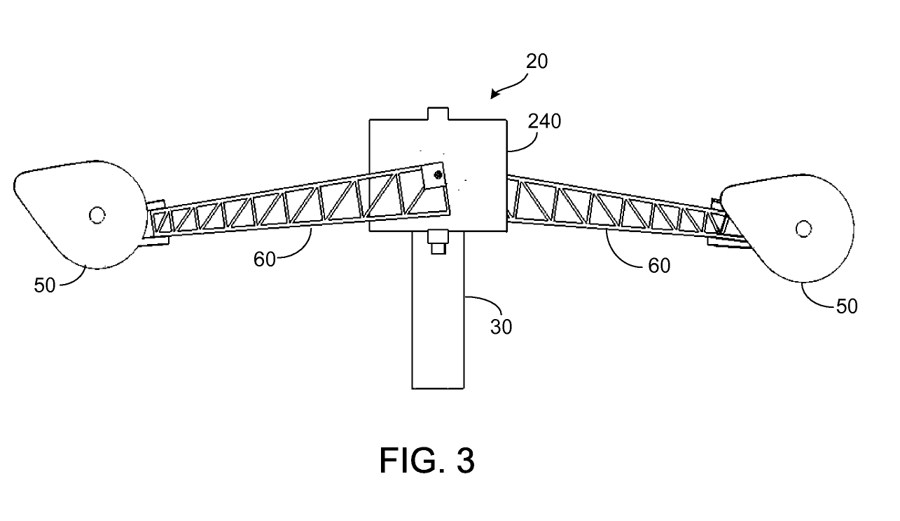

As shown in FIGS. 1-3, a plurality of the pumping mechanisms 20 may be utilized together. Further, as shown in FIG. 2, for example, adjacent pumping mechanisms 20 may be oriented in opposite directions to prevent the buoys 50 from interfering with each other while also reducing the space occupied by the plurality of pumping mechanisms 20. Such a configuration of pumping mechanisms 20 may produce a more continuous flow of pumping fluid due to the different pumping cycles of the different pumping mechanisms 20. However, it is within the scope of the disclosure that the pumping mechanisms 20 may be oriented in the same direction or any direction relative to each other.

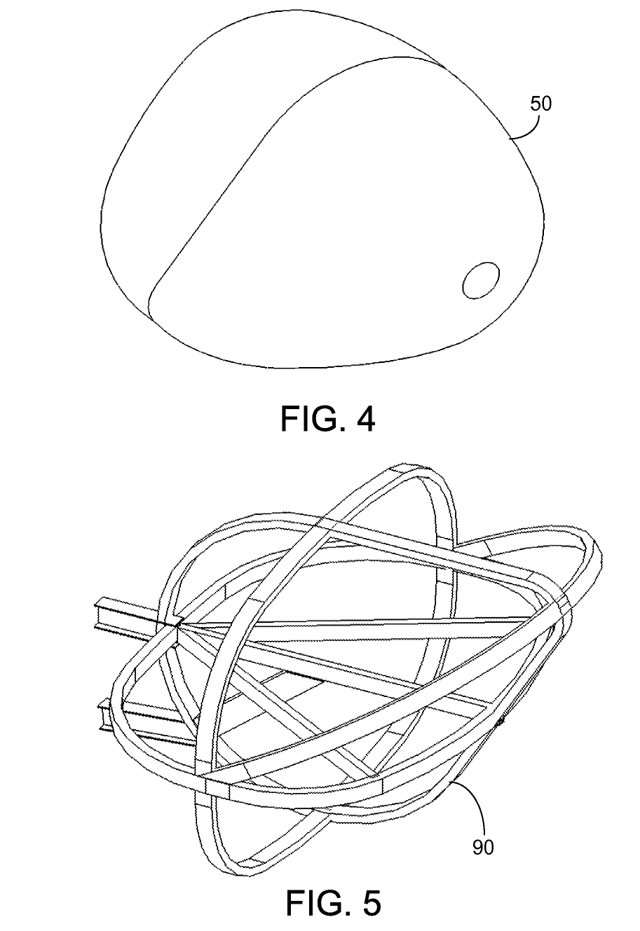

The buoy 50 may have a streamlined shape to allow fluid to efficiently pass by the buoy 50. FIGS. 1-4 show an example buoy 50 having a streamlined shape. However, the buoy 50 may be any shape, such as, for example, a sphere, ellipsoid, square, pyramid, or rectangle. The buoy 50 may also have an internal structure 90, an example of which is shown in FIG. 5. The internal structure 90 is not so limited, however, and may have any form to provide rigidity to the buoy 50 while also allowing the buoy 50 to remain buoyant. Air or foam, such as, for example, polyurethane foam, may also be included in the buoy 50. The buoy may cause arm 60 to articulate due to movements of the fluid body, which may include waves, swells, and/or any other appropriate type of fluid body movements.

The arm 60 may be formed from metal, such as stainless steel, aluminum, or any other appropriate metal. The arm 60 may also be formed from a composite material, such as concrete, fiberglass, wood, carbon fiber, polyaramide fiber, or any other appropriate composite material. Further, the arm 60 may be coated to protect the arm 60 from the environment and limit or prevent corrosion.

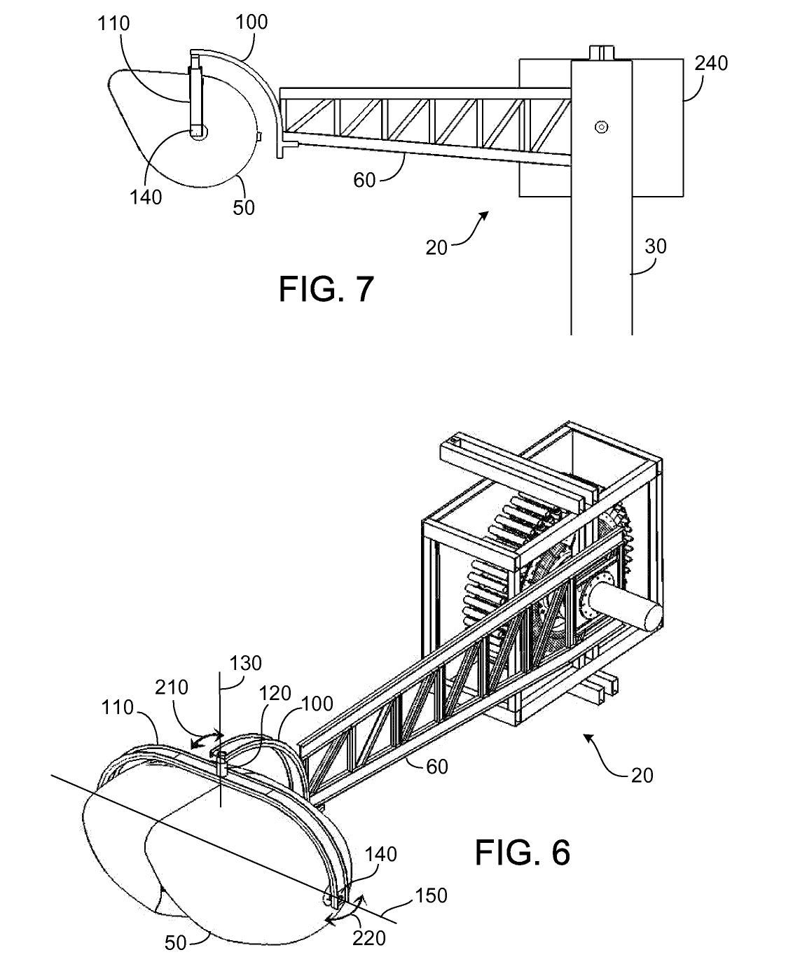

The buoy 50 may be fixedly or pivotably attached to the arm 60 in a plurality of ways. Referring to FIGS. 6 and 7, the arm 60 includes a first frame member 100. The first frame member 100 is pivotably attached to a second frame member 110 via a pivot 120 so that the second frame member 110 is pivotable about an axis 130. The buoy 50 is pivotably attached to the second frame member 110 via pivots 140 at opposing sides of the buoy 50. Accordingly, the buoy 50 pivots about an axis 150 formed by the pivots 140. As a result, the buoy 50 can articulate in the directions illustrated in FIG. 6. Thus, for example, the buoy 50 can be oriented in a direction corresponding to a movement of the fluid body.

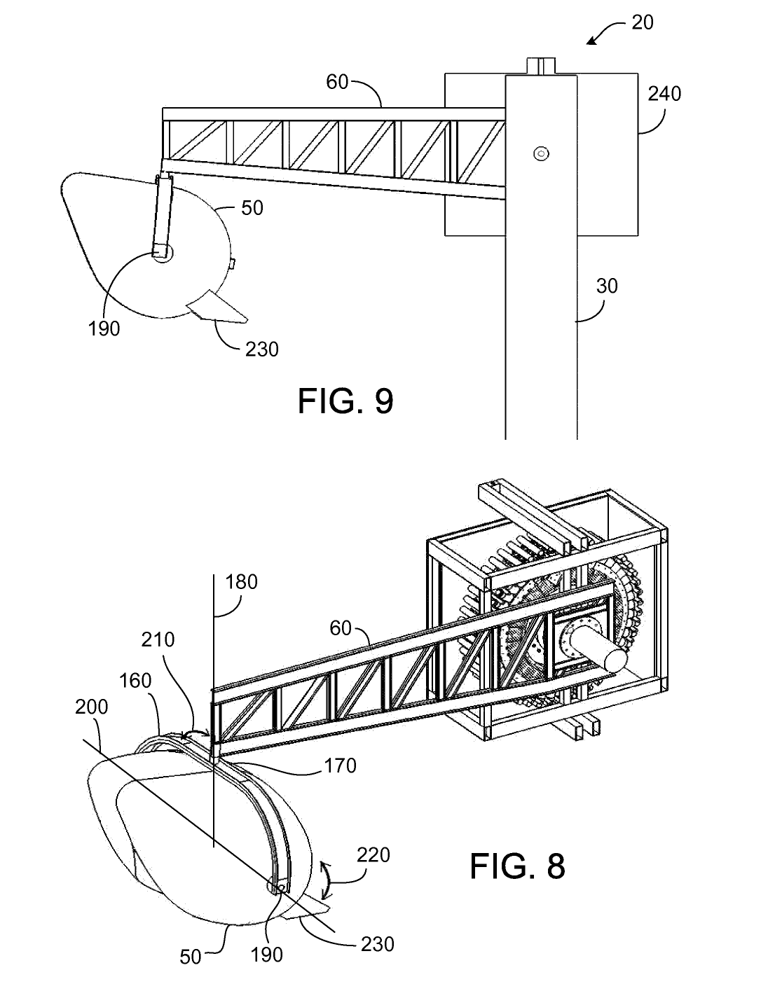

FIGS. 8 and 9 illustrate another example manner in which the buoy 50 may be coupled to the arm 60. As shown, the buoy 50 is attached to the arm 60 with a frame member 160. The frame member 160 attaches to the arm 20 via a pivot 170, permitting the frame member 160 and buoy 50 to pivot about a longitudinal axis 180 of the pivot 170. The buoy 50 attaches to the frame member 160 with pivots 190 at disposed at opposing sides of the buoy 50. Consequently, the buoy 50 is pivotable about a central axis 200 formed by the pivots 190. Arrows 210 and 220 illustrate the directions in which the buoy 50 may pivot as a result of pivots 170 and 190, respectively.

The buoy 50 may also include one or more directional members 230 (e.g., vanes, fins, or keels) operable to orient the buoy 50 in a flow direction of the fluid body, for example, as shown in FIGS. 8 and 9. As a result, the orientation of the buoy 50 can change in relation to the arm 60, for example, in order to better conform to a motion of the fluid body, which may change over time.

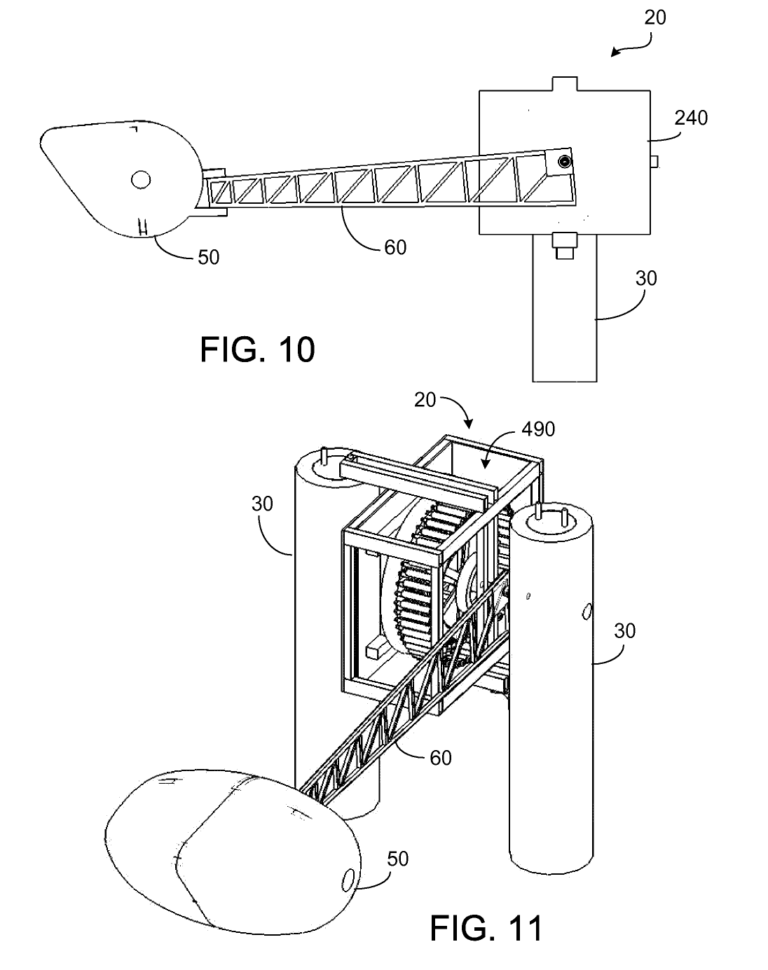

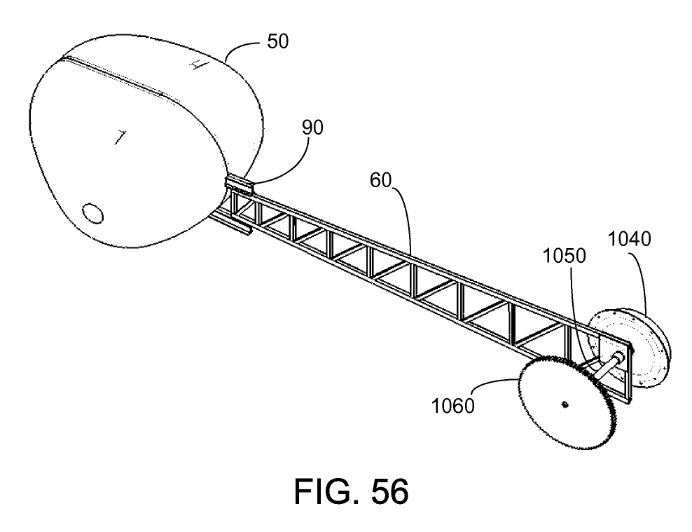

According to yet a further example, the buoy 50 may be rigidly coupled to the arm 60 via the internal structure 90. As shown in FIGS. 10-11 and 54-56, the arm 60 attaches to a portion of the internal structure 90 extending through the buoy 50.

The different implementations of coupling the buoy 50 to the arm 60 are provided as examples only and are not intended to limit the scope of the present disclosure. Further, although different implementations of the power generation system 10 presented herein are described with the buoy 50 coupled to the arm 60 in a particular way, it is understood that the buoy 50 and arm 60 of any of the power generation system 10 implementations may be coupled in any desired manner.

The pumping mechanism 20 may also include a buoy release mechanism. The release mechanism may include a cable, rope, or other flexible member extending between the buoy 50 and the arm 60. The release mechanism may be utilized in adverse weather, such as a hurricane, tsunami, or any other weather or fluid body condition that may cause damage to the pumping mechanism 20 (e.g., by causing the arm to articulate too quickly over a large angular displacement). When triggered, the release mechanism causes the buoy 50 to release from the arm 60. However, the buoy 50 is prevented from floating away and being lost by the flexible member extending between the buoy 50 and the arm 60.

The flexible member may be any suitable length to permit the buoy 50 to rise and fall with a fluid body's movements while simultaneously preventing the arm 60 from being articulated therewith. The release mechanism may be automatically triggered when large waves or other extreme conditions are experienced. For example, when forces on the buoy 50 by the wave motion exceed a predetermined value, a bolt or other structure may shear or otherwise disconnec, releasing the buoy 50 from the arm 60.

Referring again to FIGS. 1-3, the pumping mechanisms 20 are mounted to the pilings 30, which may be anchored to a bottom of a fluid body, such as a sea or ocean. The pilings 30 may be formed from wood, concrete, metal, or any other suitable material. The pumping mechanisms 20 may generally be above the fluid surface. However, the pumping mechanisms 20 may be at least partially submerged or completely submerged in the fluid body, especially due to the changing tides, waves, etc.

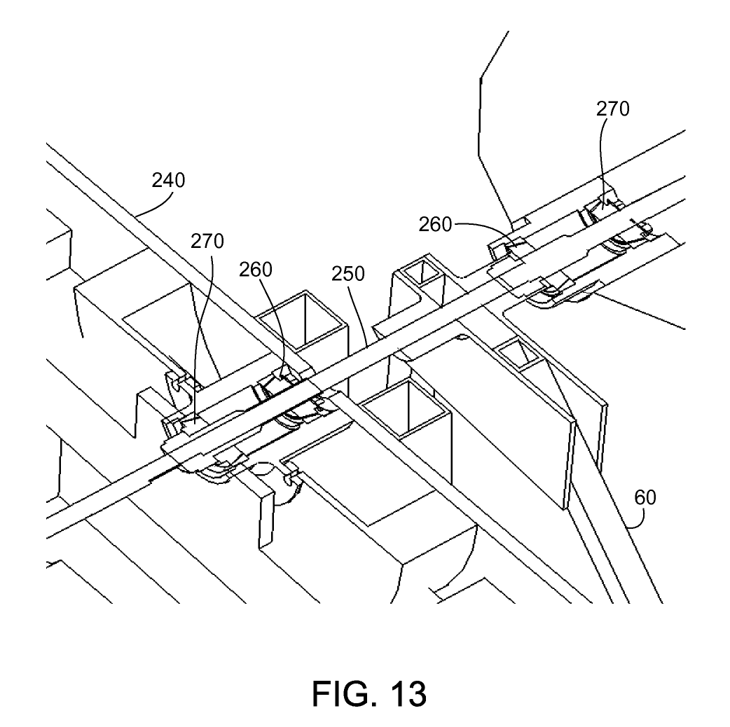

The pumping mechanisms 20 also include a housing 240 and a shaft 250 extending therefrom to which the arm 60 attaches. As each buoy 50 rises and falls with a wave motion of the fluid body, the associated arm 60 pivots, causing the associated shaft 250 to rotate. As explained below, the shaft 250 may be coupled directly or indirectly to a portion of the pumping mechanism 20 operable to pressurize and/or pump the pumping fluid (referred to interchangeably as the “fluid pump” or “pump”). The pump is described in more detail below. Consequently, the shaft 250 forms at least a part of a power transmission mechanism operable to transmit power from the arm 60 for pumping the pumping fluid. FIG. 13 and the description thereof describe additional details of the power transmission mechanism.

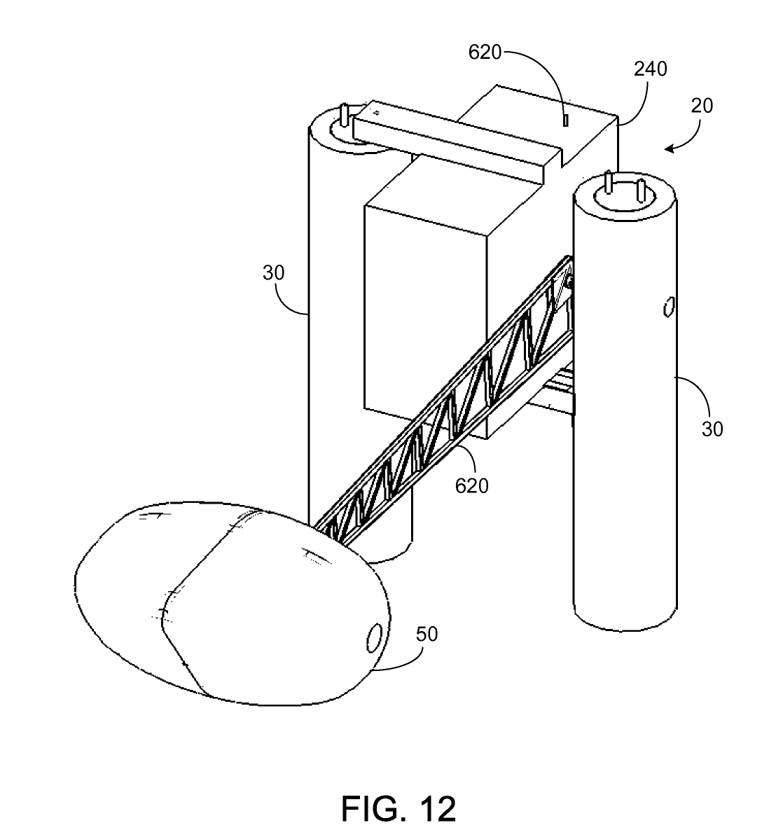

FIGS. 12-13 illustrate the attachment of the arm 60 to the shaft 250 according to one implementation. A first end of the shaft 250 extends into a piling 30 adjacent to the pumping mechanism 20, while an opposite end of the shaft 250 extends into the pumping mechanism for actuating a pump, described below. Seals 260 are provided to prevent intrusion of fluid into an interior of the pumping mechanism 20 and into the piling 30. The seals 260 also prevent intrusion of fluid into bearings 270 for the shaft 250. The shaft 250, seals 260, and bearings 270 form at least a portion of the power transmission mechanism, according to one implementation.

According to one implementation, each pumping mechanism 20 may be removable, such as for maintenance, repair, or replacement. In such an implementation, the shaft 250 may include a disconnect mechanism, such as two mating flanges secured with fasteners. Thus, when a pumping mechanism 20 is to be removed, the mating flanges may be disconnected by removal of the fasteners so that the pumping mechanism 20 may be removable as a single unit.

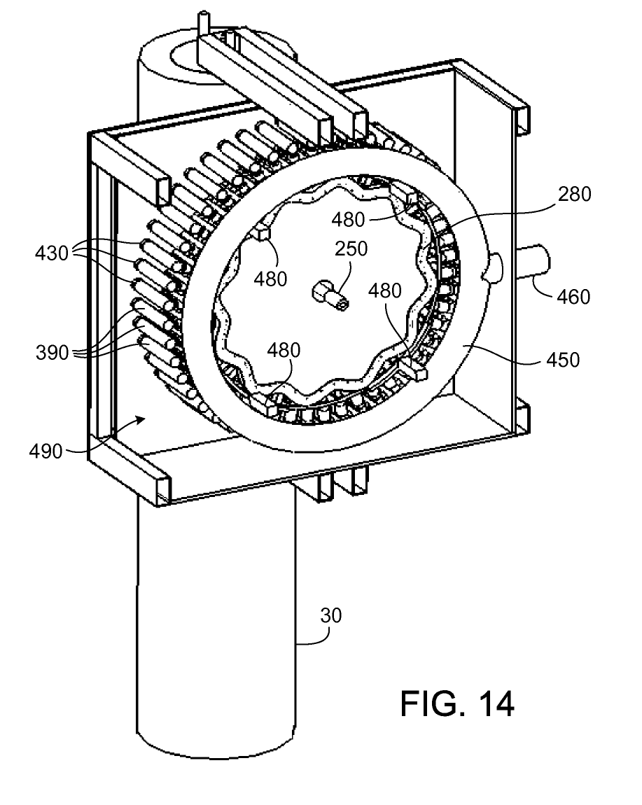

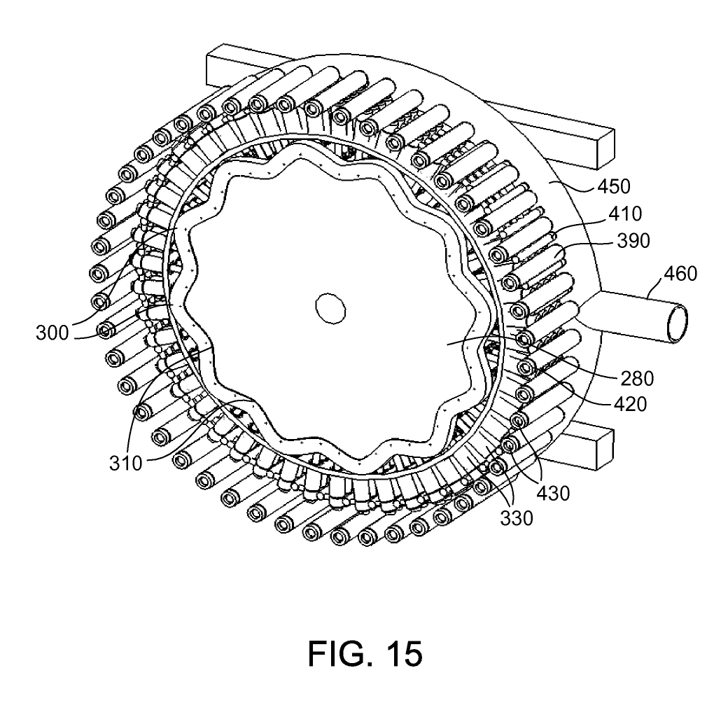

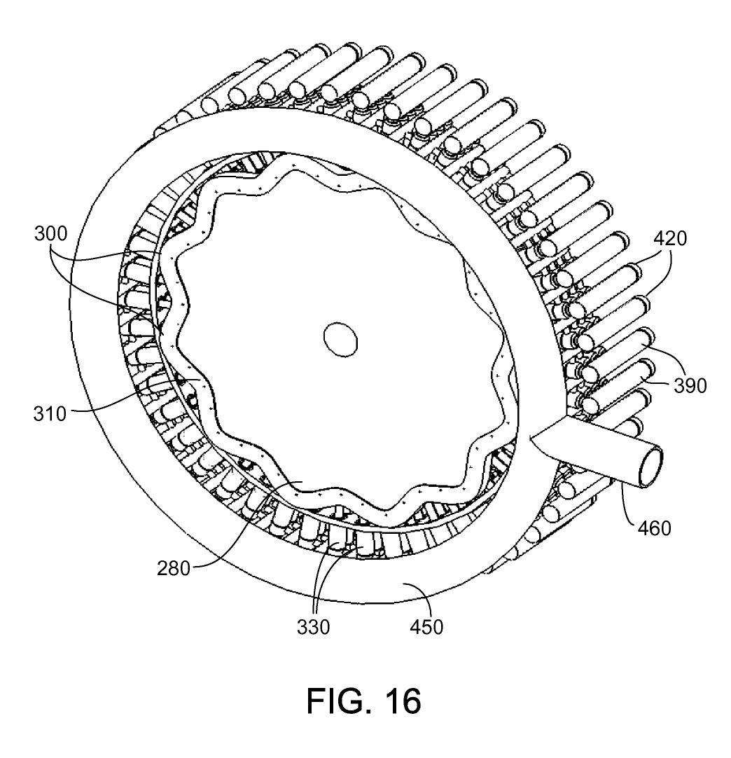

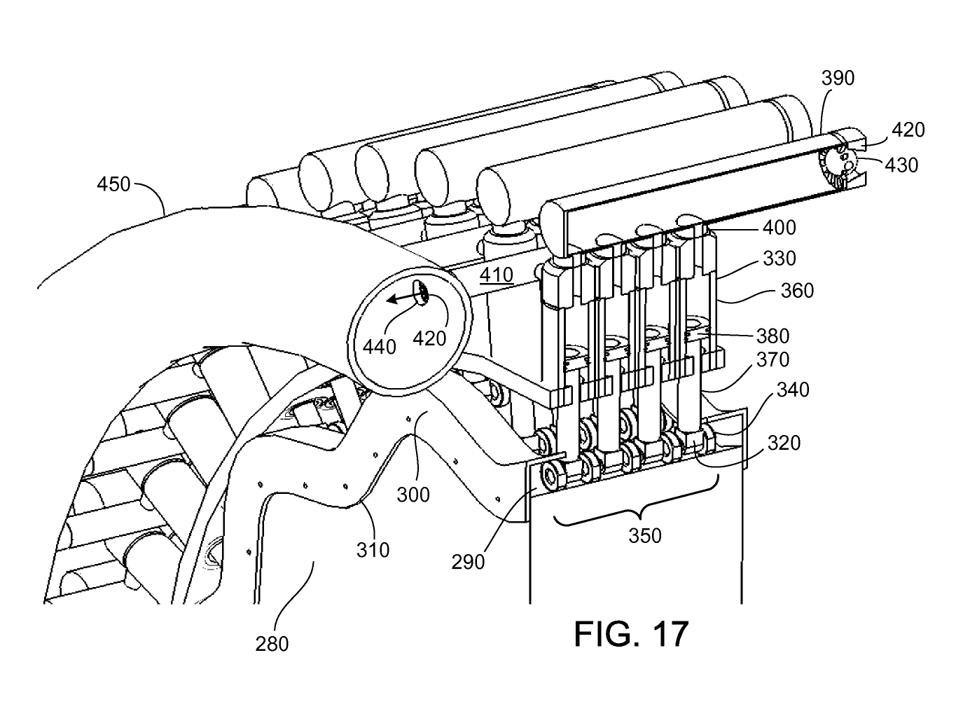

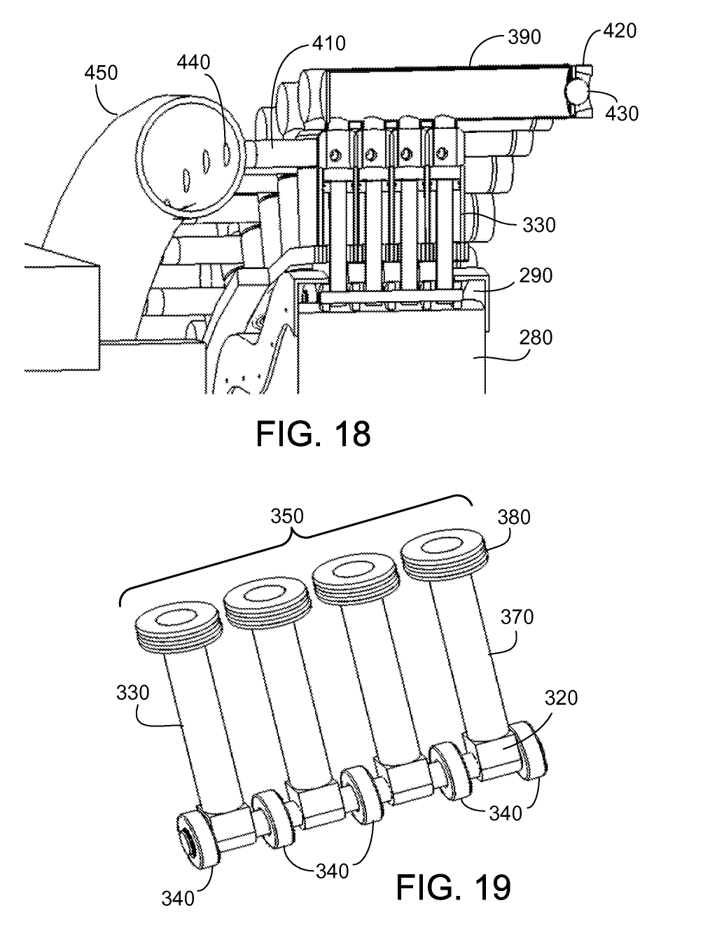

Internal operation of the pumping mechanism 20 is described with reference to FIGS. 14-19. An end of the shaft 250 attaches to a cam 280. The cam 280 includes a channel 290 having a plurality of peaks and valleys 300 and 310. The peaks and valleys 300 and 310 may, for example, be in a sinusoidal fashion. According to one implementation, the angular measure between adjacent peaks 300 (and valleys 310) is about 30°. However, it is within the scope of the disclosure that the angular measure between the peaks 300 (and valleys 310) be greater or less than 30°. Further, according to one implementation, the pumping mechanism 20 may be articulated by an approximately 16° rotation of the shaft 250 and arm 60 if there is a 1:1 correlation. That is, according to some implementations, the pumping mechanism 20 is operable with a minimum of 16° articulation of the arm 60. However, the pumping mechanism 20 may be operable with a rotation of the arm 60 greater or less than 16°.

First ends 320 of pumping cylinders 330 are captured in and moveable along the channel 290. According to one implementation, the first ends 320 of the cylinders 330 include rollers 340 that roll along the channel 290 as the cam 280 rotates. The cylinders 330 are arranged in axial rows 350 radially provided around the cam 280. As illustrated, each row 350 includes four cylinders 330, although it is within the scope of the disclosure to include fewer or more cylinders 330 in each row 350. Each cylinder 330 includes an upper portion 360, a lower portion 370 slideable within the upper portion 360, and a piston 380 attached to the lower portion 370 and also slideable within the upper portion 360. The cylinders 330 and the cam 280 form at least a portion of the pump operable to pump the pumping fluid to the power generator 40.

Each row 350 of cylinders 330 are in communication with a common inlet manifold 390 at second ends 400 of the cylinders 330 opposite the first ends 320. Each row 350 of cylinders 330 are also in communication with a common outlet chamber or conduit 410. Each outlet conduit 410 is provided proximate to the inlet manifold 390 at the second ends 400 of the cylinders 330. Each inlet manifold 390 includes a valve 420 (e.g., a check valve) provided at an inlet 430, and each outlet conduit 410 includes a valve 420 (e.g., a check valve) at an outlet 440. The outlets 440 of each outlet conduit 410 communicate with an outlet manifold 450 that collects the pumping fluid forced out of the cylinders 330 as the pumping mechanism 20 operates. The outlet manifold 450 also includes an outlet 460 for conducting pressurized pumping fluid pumped by the pumping mechanism 20 to the turbine 70 via an output conduit 470. The plurality of cylinders 330, the inlet manifolds 390, the outlet conduits 410, and the outlet manifold 450 are held stationary within the housing 240 of the pumping mechanism 20, such as with support elements 480, shown in FIG. 14.

During operation, the buoy 50 follows the wave motion of the fluid body, causing the buoy 50 to rise and fall and the arm 60 to pivot relative to the longitudinal axis of the shaft 250. The shaft 250, in turn, pivots with the rotation of the arm 60, causing the cam 140 to rotate with the action of the arm 60 and buoy 50. According to one implementation, the cam 280 is directly attached to the shaft 250, and the shaft 250 is directly attached to the arm 60 so that the amount of angular rotation of the cam 280 is the same as the amount of angular rotation of the arm 60. Thus, when the arm 60 and shaft 250 rotate in a first direction, the cam 280 also rotates in the first direction. Similarly, when the arm 60 and shaft 250 rotate in a second direction, the cam 280 also rotates in the second direction. According to other implementations, the shaft 60 and the cam 280 are connected via gearing so that the shaft 60 and the cam 280 rotate different angular amounts in response to the wave motion of the fluid body.

According to particular implementations, the interior of the pumping mechanism 20 forms a reservoir 490 filled with the pumping fluid such that at least some of the internal components of the pumping mechanism 20 are immersed in the pumping fluid. Thus, the pumping fluid may be used not only for pumping by the pumping mechanism 20 but also as a lubricant for moving parts of the pumping mechanism 20 and/or as a protectant for components of the pumping mechanism. The pumping fluid may also provide a cooling function for components of the pumping mechanism due to the circulation of the pumping fluid.

As the cam 280 rotates, the cylinders 330 follow the channel 290, causing the cylinders 330 to extend and retract, depending upon the location of any given cylinder 330 along the channel 290 and the motion of the cam 280. Thus, if a row 350 of cylinders 330 were located at a peak 300 of the channel 290 when the cam 280 began to rotate, the first ends 190 of the cylinders 330 would begin traveling towards a valley 310 of the channel 290. As a result, the lower portions 370 and pistons 380 of the cylinders 330 would move downwards relative to the upper portion 360, causing the pumping fluid to be drawn from the reservoir 490 through the valve 420 and into the inlet manifold 390 and a volume formed in the upper portions 360 above the pistons 380. Pumping fluid is prevented from entering the cylinders 330 via the outlet manifold 450 and the outlet conduit 410 because the valve 420 at the outlet 440 prevents a back flow of the pumping fluid.

Thereafter, the cam 280 may rotate in the opposite direction in response to the wave action of the fluid body. As a result, the lower portions 370 of the exemplary cylinders 330 may move upwards relative to the upper portions 220 as the first ends 320 of the cylinders 330 travel in the channel 290 from a valley 310 to a peak 300. Consequently, the pistons 380 drive the pumping fluid out of the cylinders 330 through the outlet conduit 410 and into the outlet manifold 450. The pumping fluid is prevented from flowing outward through the inlet manifold 390 because of the valve 420 provided at the inlet 430 of the inlet manifold 390. The pumping fluid output from each pumping mechanism 20 is conducted through outlet 460 to the corresponding output conduit 470.

During upward or downward movement of the buoy 50 and the arm 60, some cylinders 330 will be drawing pumping fluid from corresponding inlet manifolds 390 while other cylinders 330 are simultaneously expelling pumping fluid through corresponding outlet conduits 410, depending upon where each cylinder 330 is located along the channel 290 of the cam 280. Consequently, the pumping mechanism 20 may produce an essentially constant output of pumping fluid, depending upon the wave conditions of the fluid body.

Power generation system 10 has a variety of features. For example, as opposed to generating electrical power through burning fossil fuels (e.g., coal), electric power may be generated through using a renewable energy source with little, if any, air pollution. Thus, the energy source may be used almost indefinitely and have a small effect on air quality. As another example, the energy source may be found at a variety of locations in a variety of countries. Thus, the power generation may be scaled as needed and may have widespread use. As a further example, fluid generation system 10 may have an expanded life cycle due to enhanced lubrication and protection.

Other implementations of power generation system 10 may have additional features. For example, conditions that may indicate and/or cause adverse environmental conditions may be monitored and, if detected, contained. For instance, appropriate sensors could detect contamination/leakage of the pumping fluid and use isolation mechanisms (e.g., valves) to stop the flow of pumping fluid to and/or from a fluid pumping mechanism 20 or a turbine 70. As another example, the pumping fluid could be biodegradable. Thus, the power generation system 10 may provide a minimal impact on the environment if a problem does arise.

Although discussed in some detail, pumping mechanism 20 represents only one implementation of a pumping mechanism for power generation system 10. Many variations of pumping mechanism 20 are possible while still achieving appropriate fluid pumping. Additionally, other types of pumping mechanisms (e.g., single-acting or double-acting piston-tank arrangements) are possible. Thus, any appropriate pump for pumping a pumping fluid may be used.

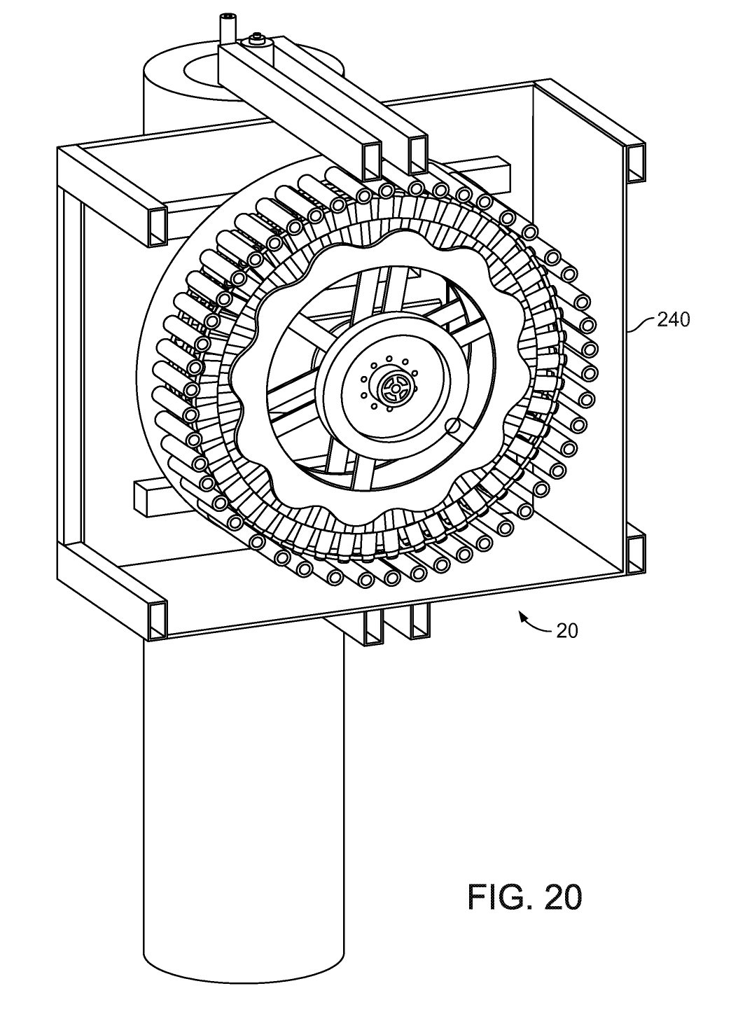

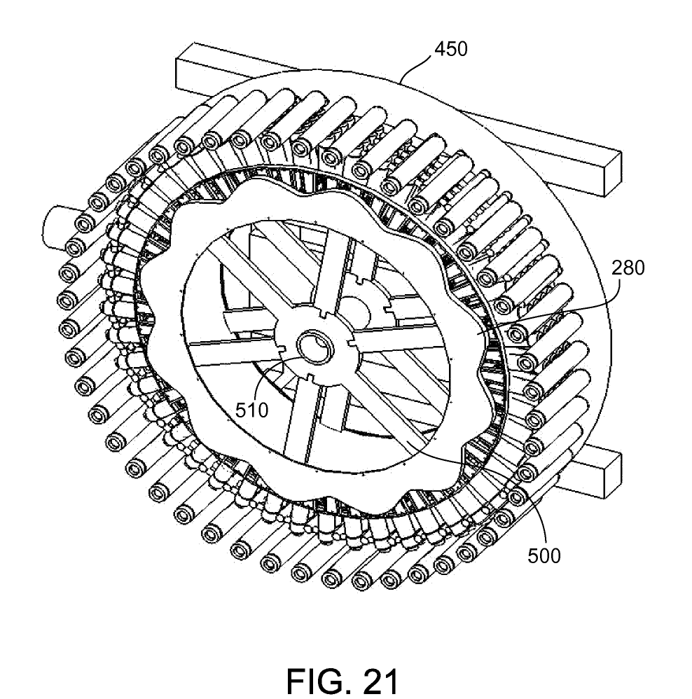

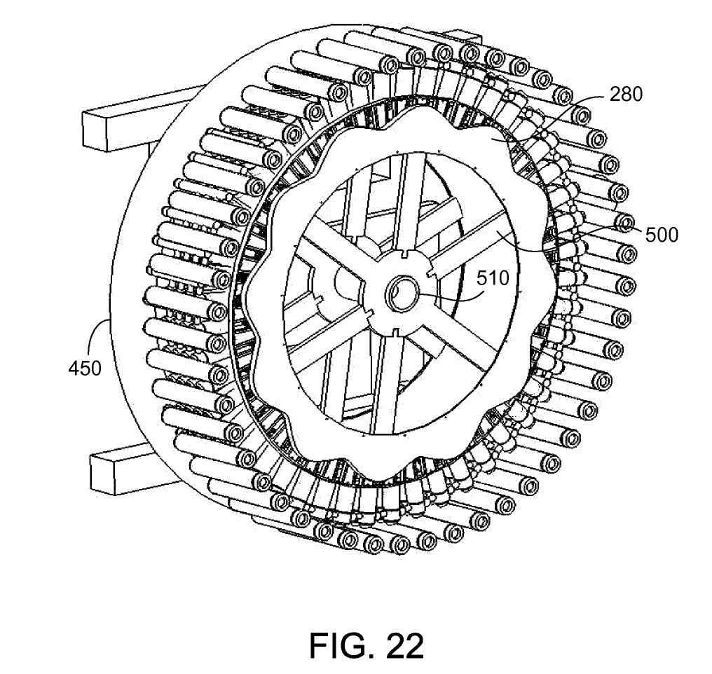

FIGS. 20-26 illustrate another implementation of the pumping mechanism 20. FIG. 20 shows the pumping mechanism 20 with a portion the housing 240 removed to show some of the internal components of the pumping mechanism 20. Referring to FIGS. 21-22, the cam 280 is wheel-shaped and includes a plurality of spokes 500 and a central hub 510 that accepts the shaft 250 (not shown).

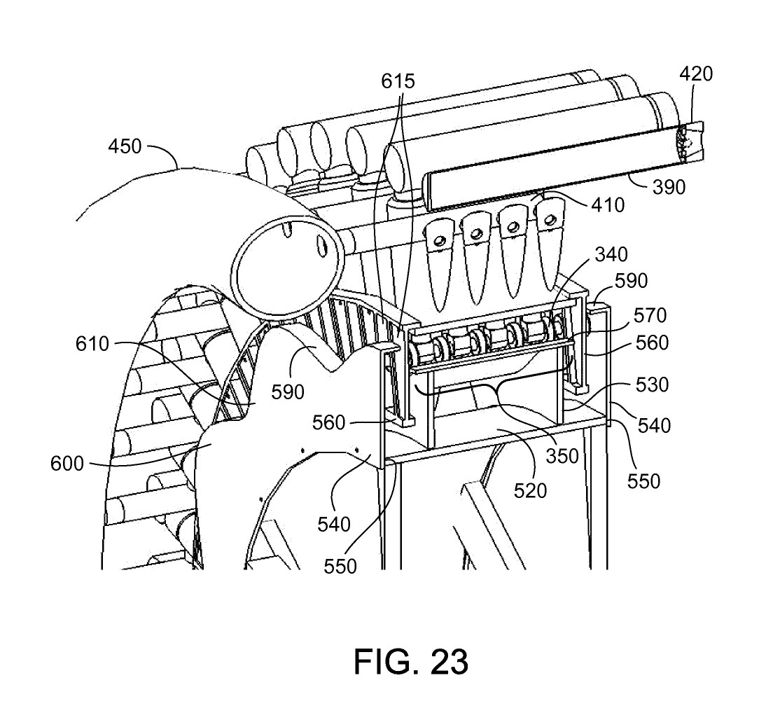

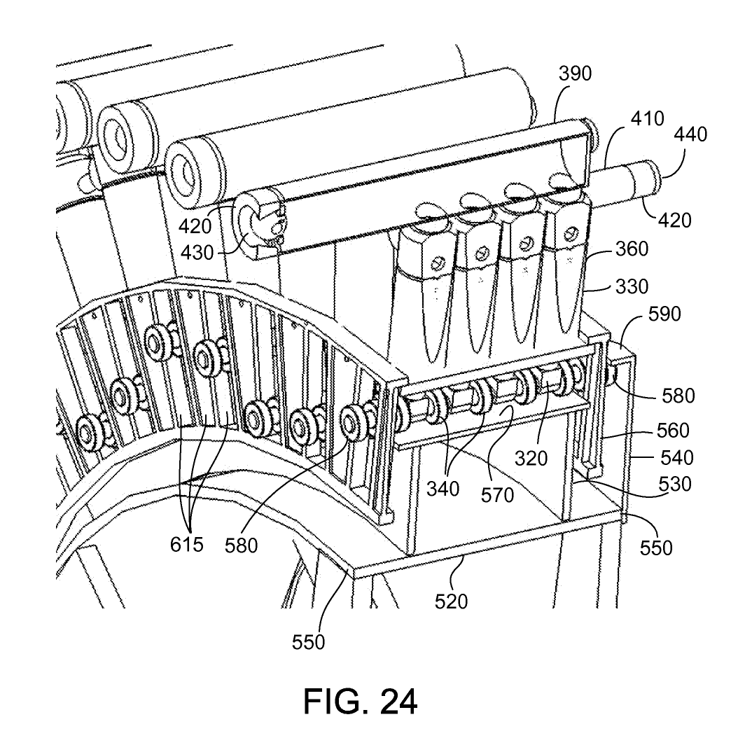

FIGS. 23-24 show a detail view of pumping mechanism 20. The cam 280 includes an outer cylindrical member 520; a raised member 530 having a plurality of peaks and valleys and extending along an outer perimeter of the cam 280; two channel members 540 provided near outer edges 550 of the cam 280; and two slotted members 560 disposed on opposite sides of the raised member 530 inward of the channel members 540. As illustrated, the cylinders 330 are arranged in axial rows 350 radially provided around the cam 280. As shown, each row 350 includes four cylinders 330, but, in other implementations, each row 350 may include more or fewer cylinders 330. Each row 350 of cylinders 330 are in communication with a common inlet manifold 390 and a common outlet conduit 410. Rollers 340 provided at the first ends 320 of the cylinders 330 roll along an outer surface 570 of the raised member 530 as the cam 280 articulates. Outer-most rollers 580 contact with lips 590 provided on the channel members 540. The lips 590 also include peaks 600 and valleys 610. The peaks and valleys of the raised member 530 align with the peaks 600 and valleys 610 of the channel members 540. The lips 590 interact with the rollers 580 so that the rollers 340 contact the outer surface 570. The slotted members 560 include a plurality of radial slots 615. A roller 340 adjacent to the outer-most rollers 580 are retained in the slots 615. Accordingly, the slots 615 restrict movement of the lower portions 370 of the cylinders 330 to a radial motion as the cam 280 rotates. That is, the slots 615 restrict the lower portions 370 of the cylinders 330 to a linear movement along a radius of the cam 280. The slots 615 may restrict the movement of the lower portions 370 over the full trajectory of the lower portions.

Accordingly, as the cam 280 rotates, the outer cylindrical member 520, the raised member 530, and the channel members 540 also rotate. Because the raised member 530 includes the plurality of peaks and valleys, the rollers 340 follow the outer surface 570 of the raised member 530, and, as a result, the lower portions 370 of the cylinders 330 move along a radial direction defined by the slots 615, into and out of the upper portions 360. As the rollers 340 of cylinders 330 move along an inclined portion of the outer surface 570 towards a peak, the raised member 530 forces the lower portions 370 of the cylinders towards the upper portions 360 of the cylinders 330, causing the cylinders 330 to compress. Consequently, the pumping fluid is forced out of the cylinders 330 and into the outlet conduit 410. As described above, the pumping fluid is prevented from exiting the inlet manifold 390 by valve 420 provided at the inlet 430 of the inlet manifold 390. As the rollers 340 travel along an inclined portion of the outer surface 570 towards a valley, the lips 590 interact with the outer-most rollers 580, driving the lower portions 370 of the cylinders 330 downward, away from the upper portions 360 of the cylinders 330. Consequently, the cylinders 330 draw in pumping fluid from the inlet manifold 390. Fluid is prevented from flowing from the outlet conduit 410 by the valve 420 provided at the outlet 440 of the outlet conduit 410.

Pumping fluid exiting the cylinders 330 via the outlet conduit 410 enters the outlet manifold 450. The pumping fluid is then directed out of the pumping mechanism 20 similar to the manner described above.

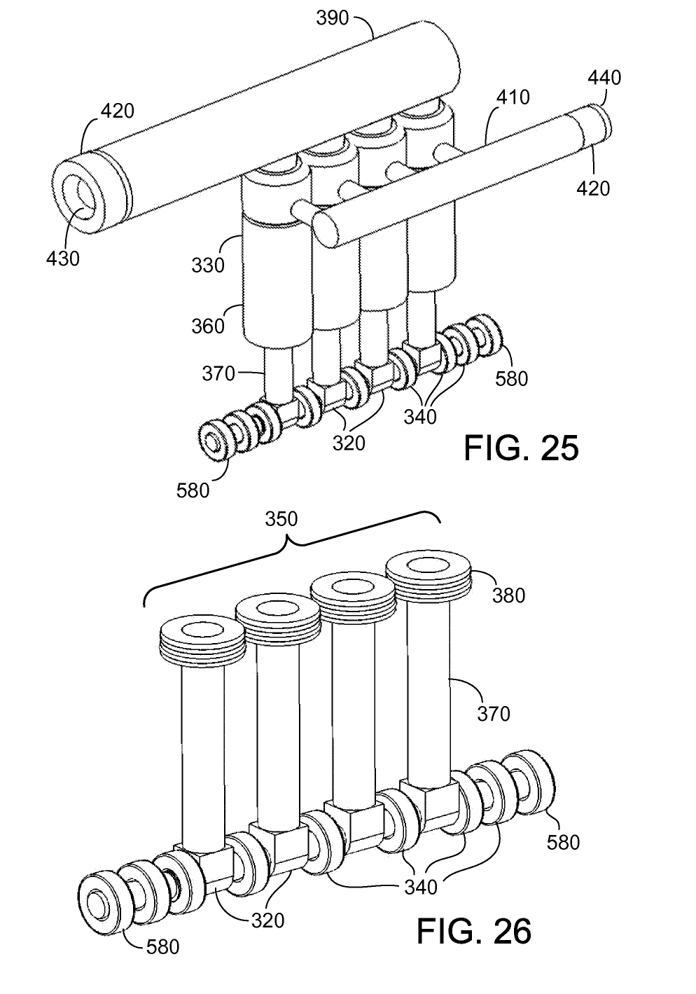

FIG. 25 shows a detail view of a row 350 of cylinders 330 and the associated inlet manifold 390 and outlet conduit 410. FIG. 26 shows lower portions 370 of a row 350 of cylinders 330, along with the associated pistons 380 and rollers 340, 580.

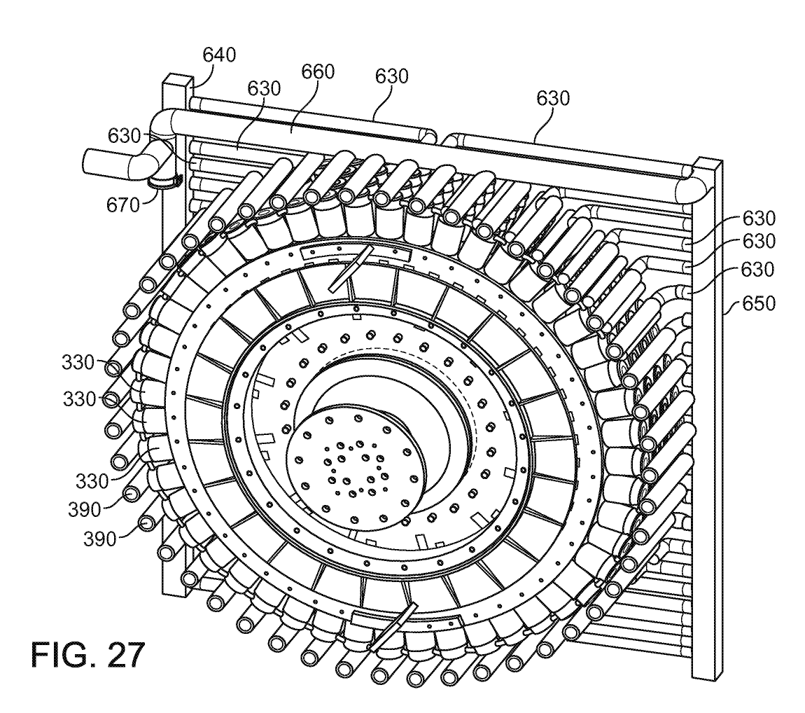

Although the above implementations of the pumping mechanism 20 are described as pumping fluid into a common outlet manifold 450, according to another implementation illustrated in FIGS. 27-29, rather than the outlet manifold 450, each outlet conduit 410 is connected to a corresponding conduit 630. Although a separate conduit 630 is shown connecting to each outlet conduit 410, two or more outlet conduits 410 may connect to a common conduit 630.

FIGS. 27-29 show some of the internal components of the example pumping mechanism 20 according to such an implementation. As explained above, the inlet manifolds 390 provide fluid communication between a row of 350 of cylinders 330 and the reservoir 490. However, as shown in FIGS. 27-29, rather than an outlet manifold 450, a plurality of conduits 630 are provided to convey the fluid away from the pumping mechanism 20.

A first set of the conduits 630 is attached and in fluid communication with a first collector 640, and a second set of the conduits 630 is attached and in fluid communication with a second collector 650. The first and second collectors 640 and 650 are joined to a conduit 660. The conduit 660 extends through an opening in the housing 240 and is coupled to the output conduit 470. The conduit 660 receives the fluid collected by both the first and second collectors 640 and 650 and conveys the fluid to the output conduit 470.

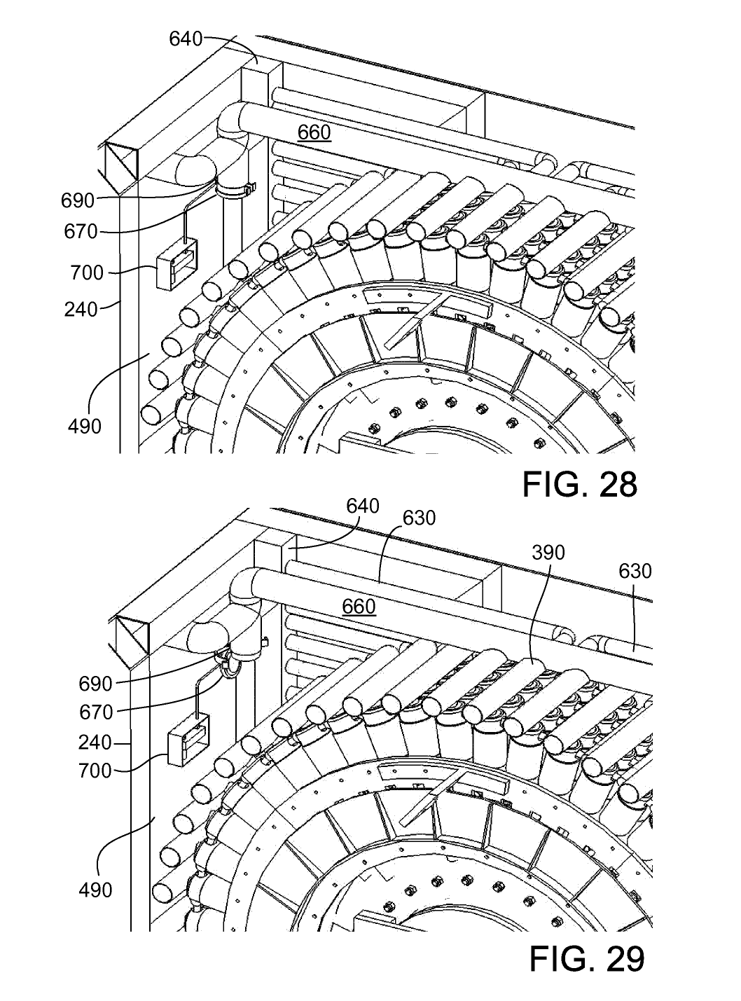

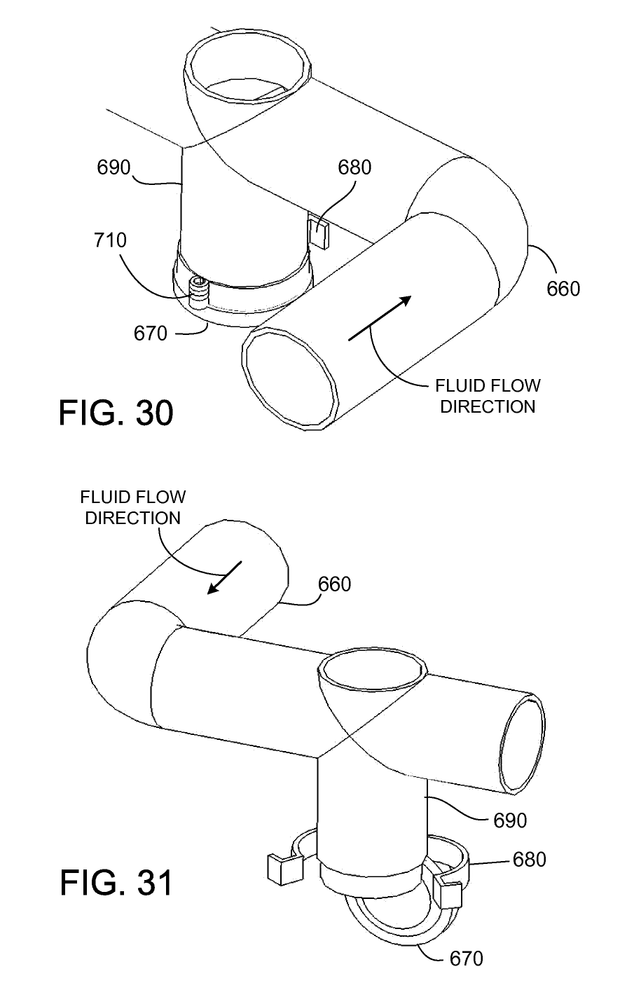

Referring to FIGS. 28-31, within the housing 240, the conduit 660 may also include a valve 670 disposed downstream of the first and second collectors 640 and 650. During normal operating conditions, the valve 670 may be secured in a closed position, such as by a lock 680. The valve 670 is provided at an end of a bypass conduit 690 that may extend downwardly from the conduit 660. A sensor 700 may also be disposed within the housing 240. For example, the sensor 700 may be secured to an inner wall surface of the housing 240. The sensor 700 may be completely or partially submerged in the fluid contained in the reservoir 490 or otherwise positioned to detect contamination of the fluid. When the sensor 700 detects contamination of the fluid, the sensor 700 may send a signal to an actuator 710 that releases the lock 680, causing the valve 670 to open. Valve 670 may, for example, be a gate valve. When the valve 670 is opened, the fluid being pumped by the pumping mechanism 20 is diverted through the bypass conduit 690 and back into the reservoir 490. Thus, the fluid being pumped is circulated from the reservoir 490, through the cylinders 330, and ultimately back into the reservoir 490 through the valve 670. Consequently, the fluid is prevented from leaving the housing 240 while the pumping mechanism 20 continues to operate, which prevents contaminated fluid from reaching the turbine 70. It is understood that, although the valve 670 is shown as a moveable member at an end of the bypass conduit 690, the valve 670 may be any valve operable to control a fluid flow, such as by selectively opening and/or closing to control the fluid flow through the bypass conduit 690.

Referring again to FIG. 1, the pumping fluid from each pumping mechanism 20 is directed to a corresponding rotatable member, such as, for example, a turbine 70, through the corresponding output conduit 470. The turbines 70 are secured to the shaft 80 and are rotatable by the pressurized pumping fluid from the output conduits 470. Therefore, as the pressurized pumping fluid rotates the turbine 70, the shaft 80 also rotates. The rotation of shaft 80 consequently drives the generator 40 to generate electrical power.

Although four pumping mechanisms 20 are illustrated, other implementations may include fewer or additional pumping mechanisms 20 joined with one or more generators 40 via a shaft 80 and corresponding turbines 70. Moreover, in certain implementations, two or more pumping mechanisms 20 may be used in a many-to-one correspondence with a turbine 70, an example of which will be discussed below. In particular implementations, for instance, a shaft 80 may be driven by only one turbine 20, which may be driven by one or more pumping mechanisms 20.

After the pumping fluid has been utilized to generate electrical power via generator 40, the pumping fluid is returned to the pumping mechanism 20 through a return conduit 620. As shown in FIGS. 1-2, the output conduit 470 extends from a side of the housing 240 while the return conduit 620 extends to a top of the housing 240. However, it is within the scope of the disclosure that each of the output conduit 470 and the return conduit 620 be connected to any portion of the housing 240, such as the top, bottom, or a side of the housing 240. For example, the return conduit 620 may be connected through the side of the housing 240 while the output conduit 470 may be connected through a top of the housing 240. In another example, both the output and return conduits 470 and 620 may be connected to the top of the housing 240 or both the output and the return conduits 470 and 620 may be connected to a side of the pumping mechanism 20. The fluid in return conduit 620 may be returned to the reservoir 490 through positive pressure, negative pressure, and/or gravity.

The return of the pumping fluid through return conduit 620 may provide a cooling process for the pumping fluid, which may in turn cool the components of pumping mechanism 20. In some implementations, the cooling may be accomplished by heat exchange with the air around return conduit 620. Particularly in coastal-based locations, but in other locations as well, a reasonably steady wind may exist, which may provide enhanced cooling. In certain implementations, return conduit 620 may be routed through the fluid body (e.g., ocean) over at least part of its length to enhance the cooling process.

As shown, the output conduit 470 has a smaller diameter than the return conduit 620 because the pumping fluid passing through the output conduit 470 has a higher fluid pressure than the pumping fluid passing through the return conduit 620. However, the conduits 470, 620 may be any size. For example, the output conduit 470 may be larger than the return conduit 620 or vice versa. Alternately, the conduits 470, 620 may be the same size.

As discussed above, a pumping mechanism 20 may be removable for maintenance, repair, or replacement. Accordingly, the output conduit 470 and return conduit 620 may include one or more shut-off valves (not shown in this implementation) disposed on opposite sides of a disconnect, which may be a pair of flanged ends abutting one another or any other mechanism for detaching one end of a conduit from another end. When disconnecting the pumping mechanism 20 from the output conduit 470 and the return conduit 620, the shut-off valves may be closed and the disconnect uncoupled. Consequently, pumping fluid is prevented from entering or leaving the pumping mechanism 20 or the output or return conduits 470, 620.

The pumping mechanisms 20 may also include a gas release to release any gas (e.g., air) trapped or otherwise contained within the housing 240 into the atmosphere. The gas release may, for example, include a pressure release valve and a conduit to convey the gas to the atmosphere.

The pumping mechanisms 20, as well as the turbines, the conduits, the shaft, and the generator, may be sized according to an intended application, taking into consideration factors such as an amount of power to be generated, the size of the average fluid body movements (e.g., waves) to be experienced, the distance from shore of the pumping mechanisms 20, the difference in height from the pumping mechanisms 20 to the turbines, etc. In general, therefore, the pumping mechanisms may be placed at various distances from shore. Moreover, in certain implementations, one or more pumping mechanisms 20 may be utilized far from shore. For example, the pilings 30 may support the pumping mechanisms 20 within a depth of the fluid body, and the associated generator 40 may be provided on an offshore platform.

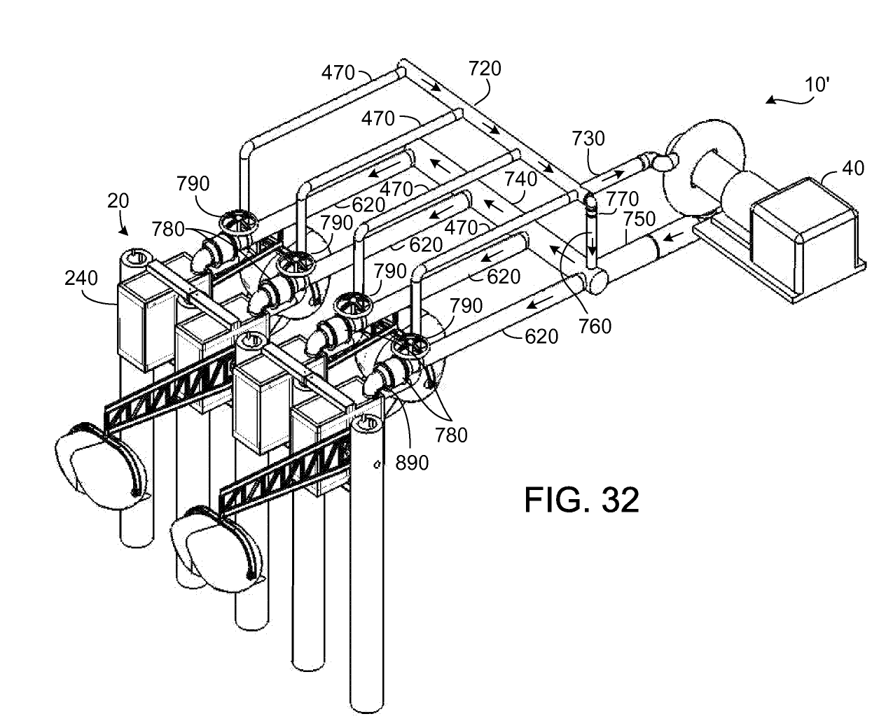

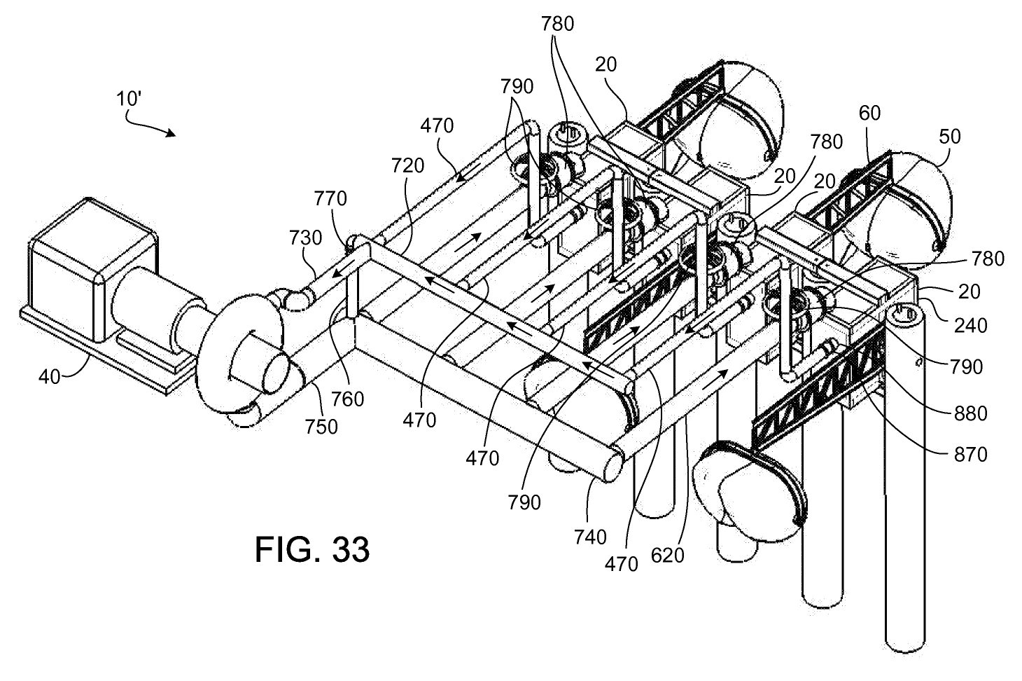

FIGS. 32-33 illustrate another implementation of the power generation system 10′ that operates in a manner similar to the system 10, described above. The system 10′ includes one or more pumping mechanisms 20, such as the pumping mechanisms 20 described above. As shown, the system 10′ includes four pumping mechanisms 20, although more or fewer pumping mechanisms 20 may be included.

The system 10′ also includes a power generator 40. The pumping mechanisms 20 are coupled to the power generator 40 through a system of conduits, including output conduits 470 and return conduits 620. An output conduit 470 and a return conduit 620 is in fluid communication with each pumping mechanism 20. As shown, the output conduits 470 join to a common manifold 720. A supply conduit 730 extends between the common manifold 720 and the turbine 70. The return conduits 620 are also connected to a common manifold 740 which is connected to the turbine 70 via a return conduit 750. A bypass conduit 760 extends between the common manifolds 720 and 740 and includes a valve 770 disposed therein. The valve 770 may be, for example, a pressure relief valve. Consequently, if a pressure in the common manifold 720 exceeds a selected pressure, the valve 770 may open, causing all or a portion of the pumping fluid to be conveyed into the common manifold 740.

Each return conduit 620 may include a valve 780 and a valve 790. Valve 780 may be a sensor actuated valve and may be actuated in response to a signal from a sensor provided within the housing 240, for example. Valve 790 may be manually actuated. For example, valve 790 may be actuated via a hand-crank. As discussed in more detail below, the valve 780 may be operable to stop flow of the pumping fluid through the return conduit 620 when a predetermined condition is detected at the pumping mechanism 20. For example, the valve 780 may be closed when a selected amount of water or other contaminant is detected in the pumping fluid or when a leak is detected.

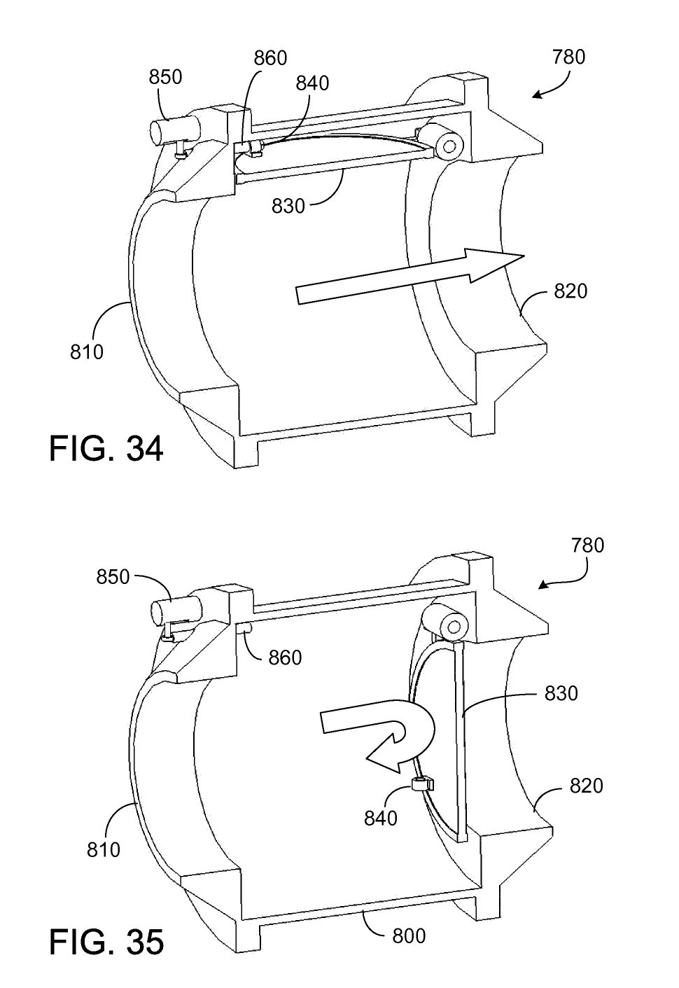

FIGS. 34-35 show an example valve 780 including a body 800 having first and second openings 810 and 820 and a gate 830 pivotable within the body 800. During normal operations, the gate 830 may be fixed in an open position providing open communication between the first and second openings 810 and 820. If contamination or a leak is detected, the gate 830 may be released and pivot downwardly into a closed position, preventing fluid from passing through the valve 780. According to the example valve shown in FIGS. 34 and 35, the gate 830 includes an appendage 840 extending therefrom. Thus, when a condition is detected, an actuator 850 retracts a pin 860 extending through an opening formed in the appendage 840, and the gate 830 pivots downwardly, sealing the valve 780.

During normal operations, the valve 790 may be in an open condition, permitting fluid to flow therethrough. However, the valve 790 may be closed, thereby preventing a flow of fluid into the housing 240. For example, the valve 790 may be closed in order to remove or perform maintenance on the valve 780 and/or pumping mechanism 20. Consequently, closing one or more of valves 780 and 790 at least partially isolates the corresponding pumping mechanism 20.

Further, the sensor 700 (described above in relation to FIGS. 28 and 29) may also send a signal to the actuator 850 of the valve 780, closing the valve 780, so that both the valve 780 and the valve 670 work in combination to isolate the pumping mechanism 20 when contamination in the fluid is detected. The sensor 700 in combination with valve 670 and, optionally, the valve 780 are operable to stop the flow of fluid from the pumping mechanism 20 to the power generator 40 while the pumping mechanism 20 continues to operate.

Referring to FIG. 33, each pumping mechanism 20 may also include a valve 870. The valve 870 may be actuated to stop flow of the pumping fluid into or out of the pumping mechanism 20. The valve 870 may, for example, be a check valve that permits flow of the pumping fluid out of the pumping mechanism 20 and into the output conduit 470 but prevents flow of the pumping fluid into the pumping mechanism 20 through the output conduit 470. The valve 870 may also be coupled to a sensor so that the valve 870 actuates upon determination of a predetermined condition. For example, the valve 870 may be coupled to the sensor 700 and may be actuated to reduce or stop flow of the pumping fluid out of or into the pumping mechanism 20 when the predetermined condition occurs. The predetermined condition may be detection of contamination in the pumping fluid, for example. Thus, when the predetermined condition is detected, the valves 670, 780, and 870 and the sensor 700 may cooperate to isolate the pumping mechanism 20 from the rest of the power generation system 10′.

The sensor 700 may actuate one or more of the valves upon the occurrence of a predetermined condition. Further, other valves may be provided at other locations of the power generation system 10′ to reduce or stop flow of the pumping fluid and may be coupled to the sensor 700 and/or one or more different sensors to detect one or more predetermined conditions. Thus, the power generation system 10′ may minimize problems due to a variety of issues with the pumping fluid (e.g., contamination and leaks), as well as allow for other processes (e.g., maintenance, repair, and/or replacement).

Power to the sensor 700, one or more of the valves 670, 780, and 870, or other devices may be provided, for example, by a power line, battery, or any other power source, such as solar power. Further, the sensor 700 may be adapted to provide an alarm signal when the predetermined condition is detected. For example, the sensor 700 may send the alarm signal to one or more lights disposed on the pumping mechanism 20. Further, the alarm system may be transmitted via a wired or wireless connection to a remote user to indicate the occurrence of the predetermined condition.

Referring again to FIGS. 32 and 33, each pumping mechanism 20 may also include a flow rate sensor 880 provided in the output conduit 470 and a flow rate sensor 890 provided in the return conduit 620. The flow rate sensors 880 and 890 are operable to measure a flow rate of the pumping fluid passing through the output conduit 470 and the return conduit 620, respectively. According to some implementations, the flow rate sensors 880 and 890 may transmit a signal indicating the measured flow rate of the pumping fluid to a controller. The flow rate measurements may be compared, and an alarm may be triggered if a difference between the flow rate measurements exceeds a selected amount. For example, the flow rate sensors 880 and 890 may transmit the flow rate measurements to a central controller that may compare the measurement values and determine if a difference, if any, exceeds a predetermined amount, which may, for example, indicate a leak. Further, the controller may open or close one or more of the valves 670, 780, and 870 in order to adjust an amount of the pumping fluid conveyed to or from the pumping mechanism 20 or stop flow of the pumping fluid to or from the pumping mechanism 20 or both. The central controller may be a human user or may be a mechanical or electronic device operable to receive, analyze, and transmit signals.

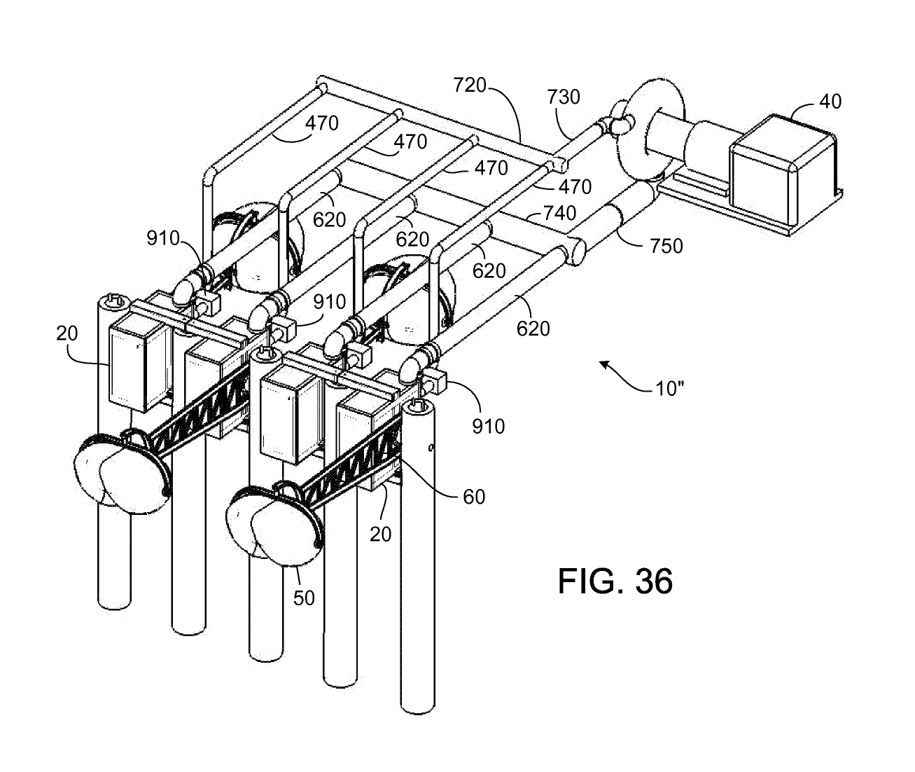

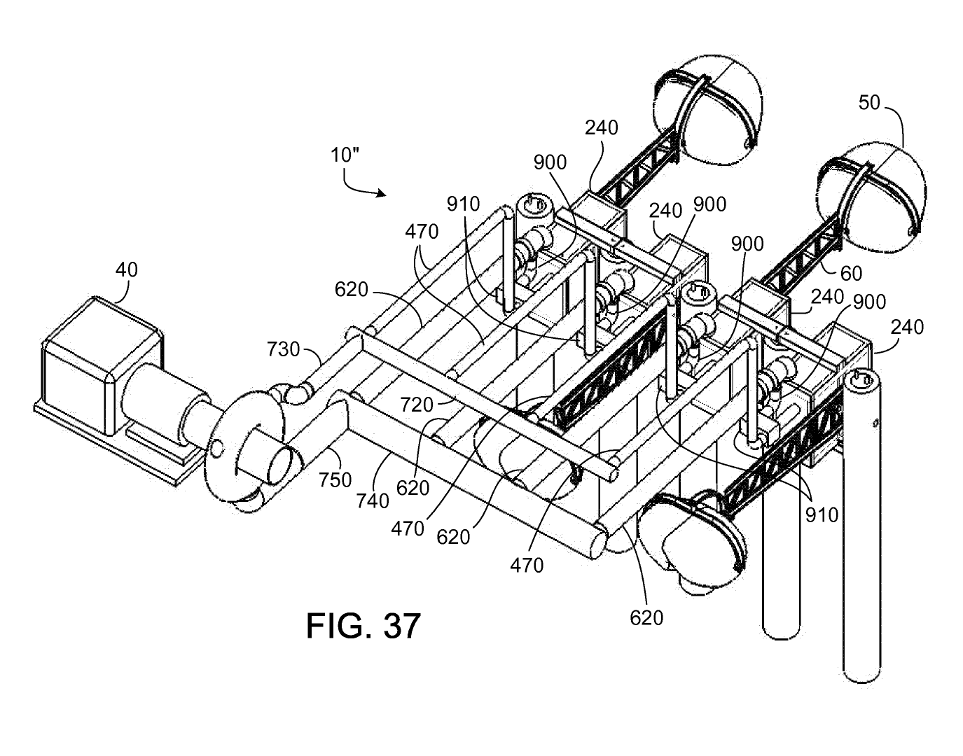

FIGS. 36 and 37 show another example power generation system 10″ and components thereof. The power generation system 10″ includes a plurality of pumping mechanisms 20 that operate in a similar manner to the pumping mechanisms described above. As shown, four pumping mechanisms 20 are coupled to a power generator 40, although more or fewer pumping mechanisms 20 may be used. As in the implementations described above, each pumping mechanism 20 has a corresponding output conduit 470 and an return conduit 620.

A bypass conduit 900 is disposed between each of the corresponding output conduits 470 and return conduits 620. A bypass valve 910 is disposed in the bypass conduit 900 (shown in FIG. 37) and is discussed in more detail below. As shown, the return conduit 900 is connected to a top of the housing 240 of the corresponding pumping mechanism 20 to return pumping fluid thereto. However, the return conduit 900 may instead be connected at other portions of the housing 240, such as a side of the housing 240.

The output conduits 470 join to a common manifold 720 that is connected to the power generator 40 via a supply conduit 730. The return conduits 620 are joined to a common manifold 740 that is connected to the power generator 40 via a return conduit 750. Thus, the pumping mechanisms 20 pump fluid though the corresponding output conduits 470, through the common manifold 720 and the supply conduit 730, and into the power generator 40. The fluid is returned to the pumping mechanisms 20 via the return conduit 750, the common manifold 740, and the respective return conduits 620.

As described above, the pumping mechanism 20 may also include a sensor (not shown in this implementation). The sensor may be disposed within the reservoir of the pumping mechanism 20, within an enclosure housing the bypass valve 910, or within one of the output conduits 470, the bypass conduit 900, or the return conduit 620. The sensor may be operable to detect one or more predetermined conditions, such as contaminants within the pumping fluid. Contaminants may include dirt, water, or chemical impurities, for example. The sensor may be communicably coupled to the bypass valve 910. If a predetermined condition is detected at the pumping mechanism 20, the sensor may send a signal to the bypass valve 910 adjusting a position thereof. For example, the sensor may command the bypass valve 910 to close or otherwise redirect a flow of the pumping fluid. For example, the sensor may adjust a position of the bypass valve 910 to cause the pumped fluid to pass through the bypass conduit 900 and into the return conduit 620. Consequently, when contamination is detected, the pumped fluid may be prevented from being conveyed to the power generator 40 and, rather, may be circulated back into the pumping mechanism 20. Thus, in the event of contamination, the pumping mechanism 20 may continue to operate in response to a motion of the fluid body while the pumping fluid is prevented from being conveyed to the power generator 40. In certain implementations, the bypass valve 910 may return the pumping fluid to housing 240 without the fluid flowing into return conduit 620.

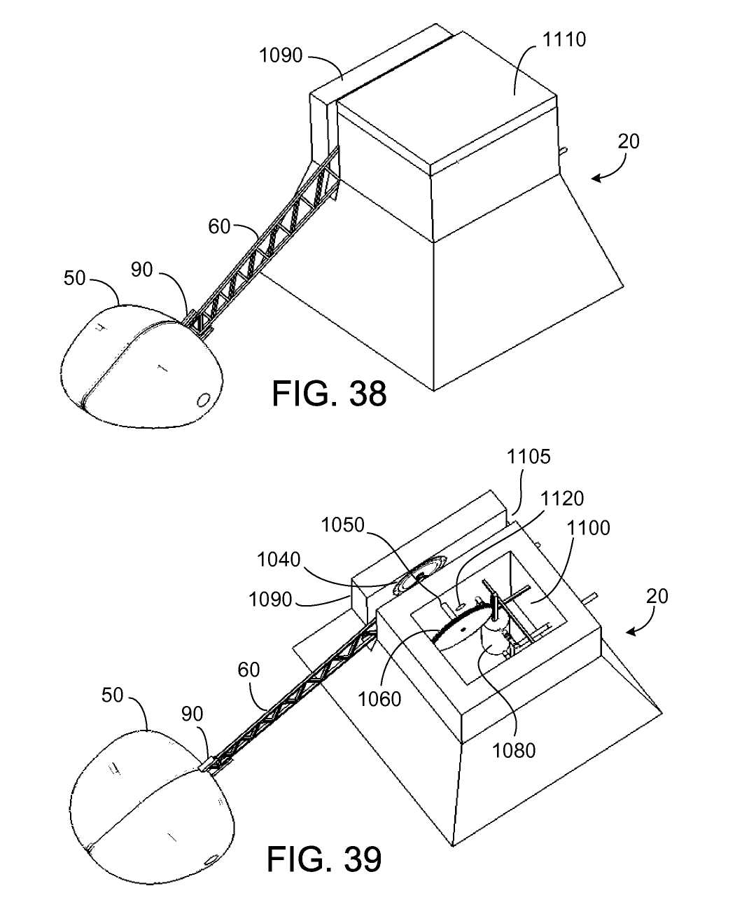

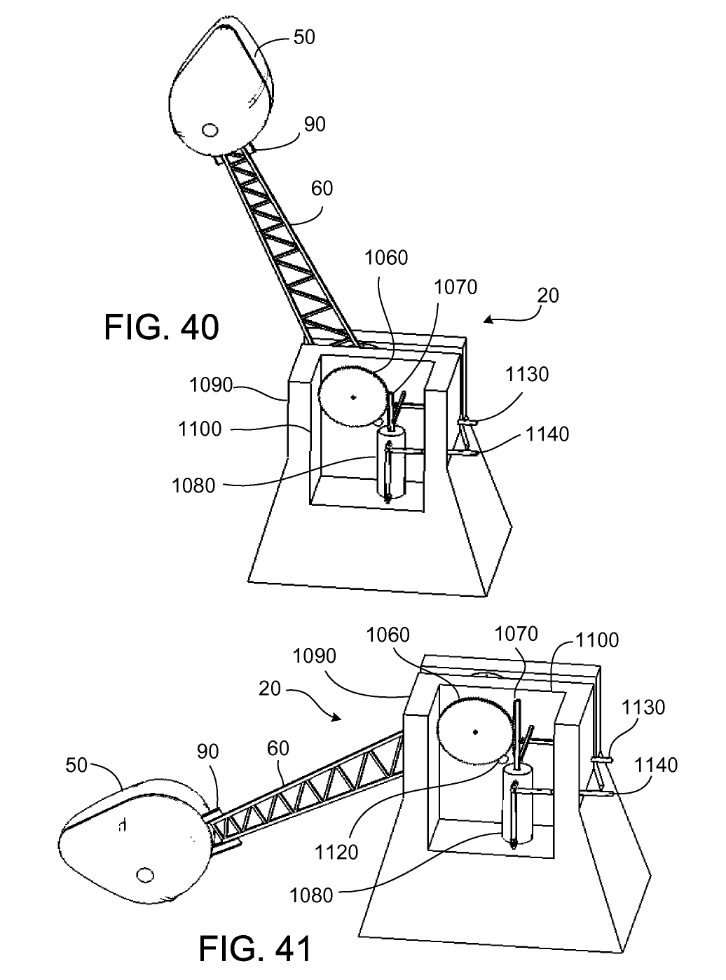

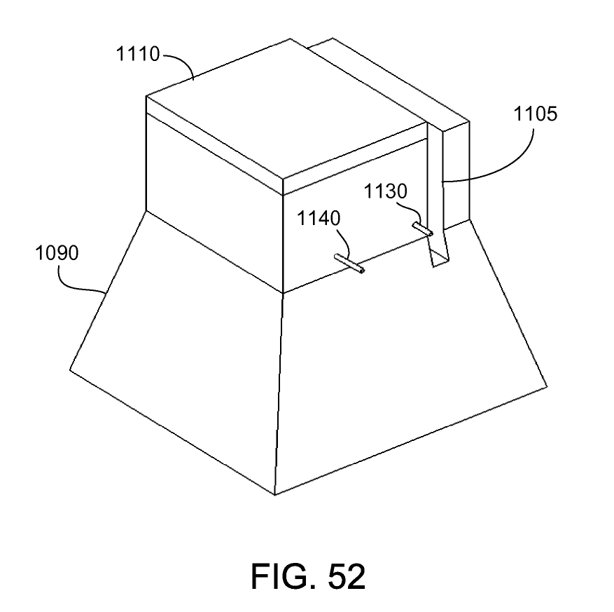

FIGS. 38-39 show another implementation of the pumping mechanism 20 according to one implementation for harnessing dynamic energy of a fluid source. For example, the pumping mechanism 20 may be utilized to convert a wave motion of a large fluid body (e.g., an ocean, sea, or lake) into a pumping motion to pump a fluid. Referring to FIG. 38, the pumping mechanism 20 includes a base 1090 and a lid 1110 to enclose a chamber 1100 (shown in FIGS. 39-41 and 50-51) having an opening adjacent the lid 1110. In particular implementations, the base 1090 and lid 1110 are formed from concrete. However, the base 1090 and lid 1110 may be formed from any other suitable material, such as a material resistant to one or more types of fluid, including sea water, and having sufficient strength to anchor and protect the pumping mechanism 20. For example, the base may also be formed from metal, a naturally occurring material, such as rock, or any other appropriate material. According to one implementation, a watertight seal is formed between the lid 1110 and the base 1090.

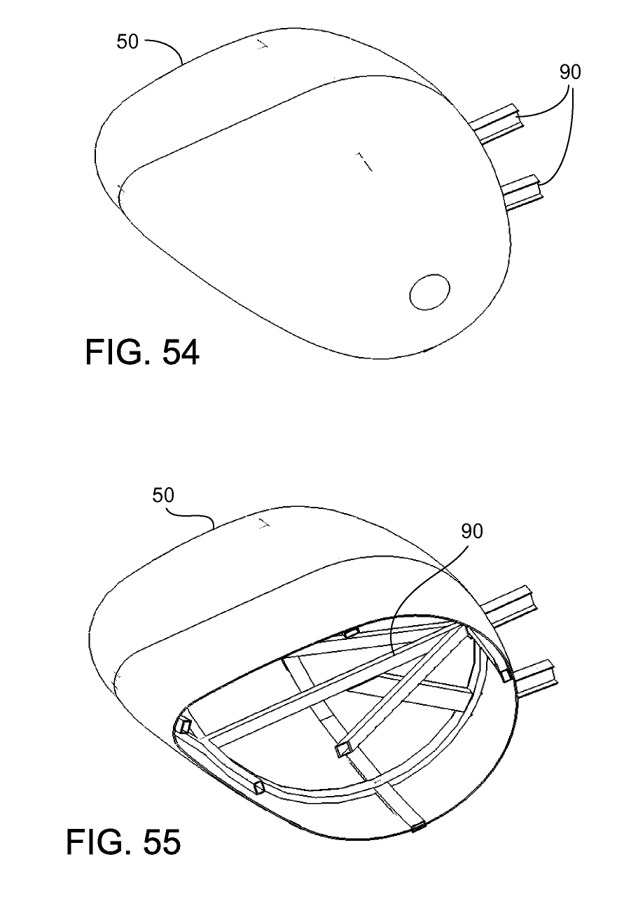

The arm 60 extends from the base 1090 and has the buoy 50 coupled to one end thereof. The buoy 50 may be formed in any shape and may include an internal structure. As described above, the buoy 50 may include an internal structure 90, shown in FIG. 55. The buoy 50 may be fixedly or pivotably attached to the end of the arm 60, for example, according to one or more manners described above.

Referring again to FIGS. 39-41 and 50-51, the chamber 1100 is formed in the base 1090 to house internal components of the pumping mechanism 20 as well as to act as a reservoir for a pumping fluid. Thus, the pumping fluid may be used not only for pumping by the pumping mechanism 20 but also as a lubricant for moving parts of the pumping mechanism 20 and/or as a protectant for components of the pumping mechanism. The pumping fluid may also provide a cooling function for the components of the pumping mechanism due to the circulation of the pumping fluid. According to one implementation, the pumping fluid is a hydraulic oil, although the pumping fluid may be any other appropriate fluid.

The chamber 1100 may be accessed by removing the lid 1110 from the base 1090. The base 1090 also includes a slot 1105 adjacent to the chamber 1100. Referring to FIG. 52, the pumping mechanism also includes a fluid inlet conduit (e.g., a pipe) 1130 and a fluid outlet conduit 1140 extending through respective openings formed in the base 1090. The inlet conduit 1130 includes an outlet 1120 formed in a wall of the base 1090 between the chamber 1100 and the slot 1105. However, the outlet 1120 may be provided at other locations in the chamber 1100. The fluid in inlet conduit 1130 may be drawn into chamber 1130 through positive pressure, negative pressure, and/or gravity.

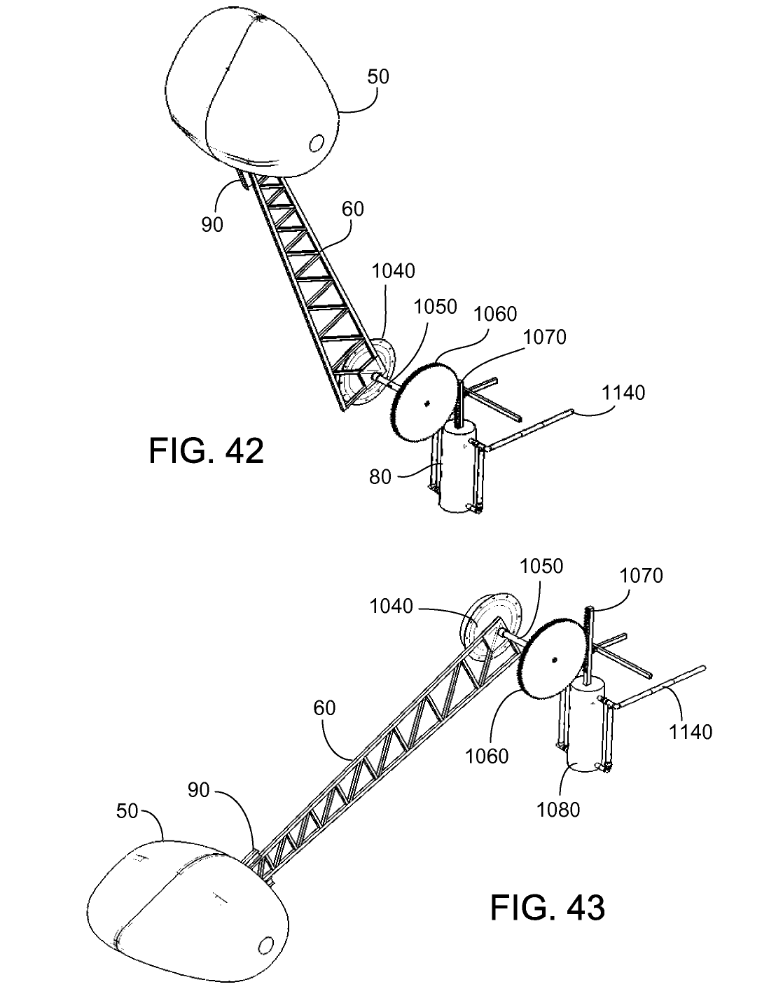

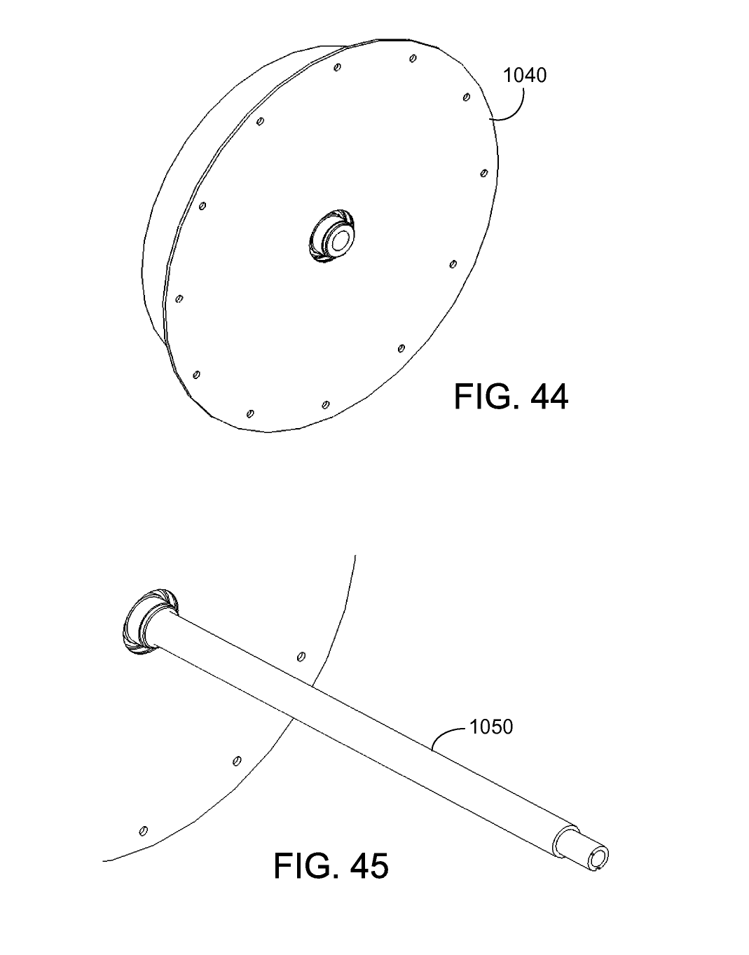

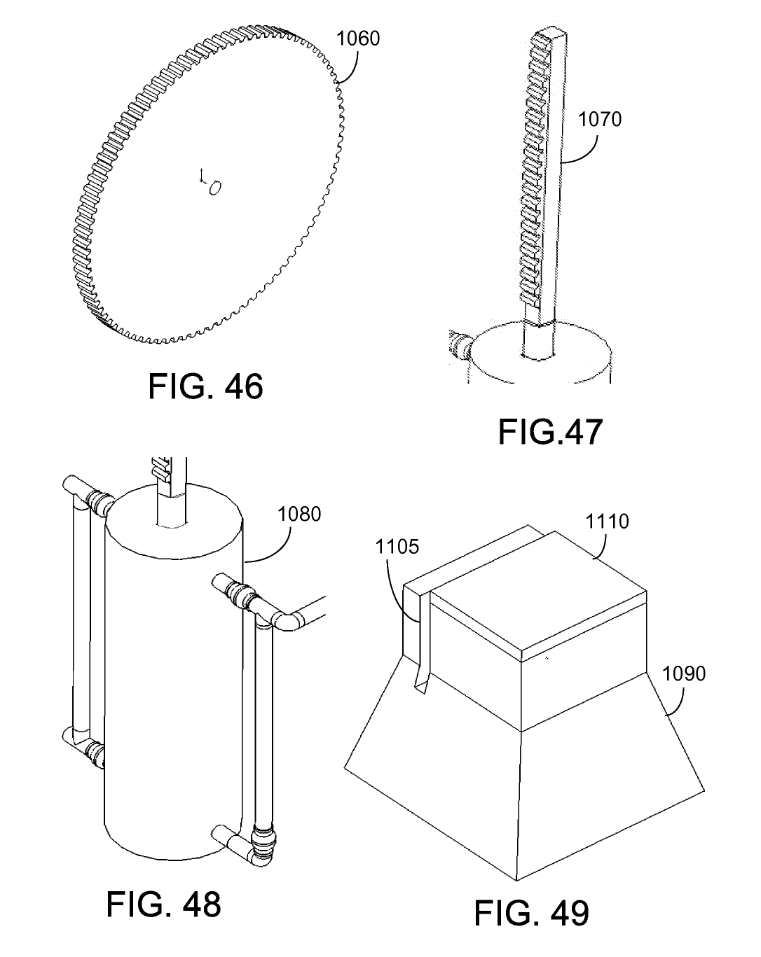

Referring to FIGS. 42-48, the pumping mechanism 20 also includes a sealed bearing 1040; a pinion gear 1060; a shaft 1050 attached to and rotatable in the sealed bearing 1040 at one end and attached to the pinion gear 1060 at an opposite end; a pumping tank 1080; a piping arrangement; and a rack gear 1070. The arm 60 is coupled to the shaft 1050 at a position along the length of the shaft 1050. The arm 60 is coupled to the shaft 1050 proximate to a first end of the arm 60, while the buoy 50 is coupled proximate to an end of the arm 60 opposite the shaft 1050. The pinion gear 1060 and the rack gear 1070 form at least a portion of a power transmission system for transmitting movements from the arm 60 to the piston housed in the pumping tank 1080. Referring to FIG. 39, the pinion gear 1060, the rack gear 1070, the pumping tank 1080, a portion of the piping arrangement, and a portion of the shaft 1050 reside in the chamber 1100. The sealed bearing 1040 may be attached to or recessed in a wall defining the slot 1105. Accordingly, the shaft 1050 extends across the slot 1105 and through an opening (not shown) formed through a wall of the base 1090 dividing the slot 1105 and the chamber 1100. According to particular implementations, a watertight seal is formed between the shaft 1050 and the base 1090, although a watertight seal need not be formed between the base 1090 and the shaft 1050 in other implementations. The arm 60 is pivotable in the slot 1105. The pinion gear 1060 and pumping tank 1080 are arranged so that the gear teeth of pinion gear 1060 and the rack gear 1070 intermesh.

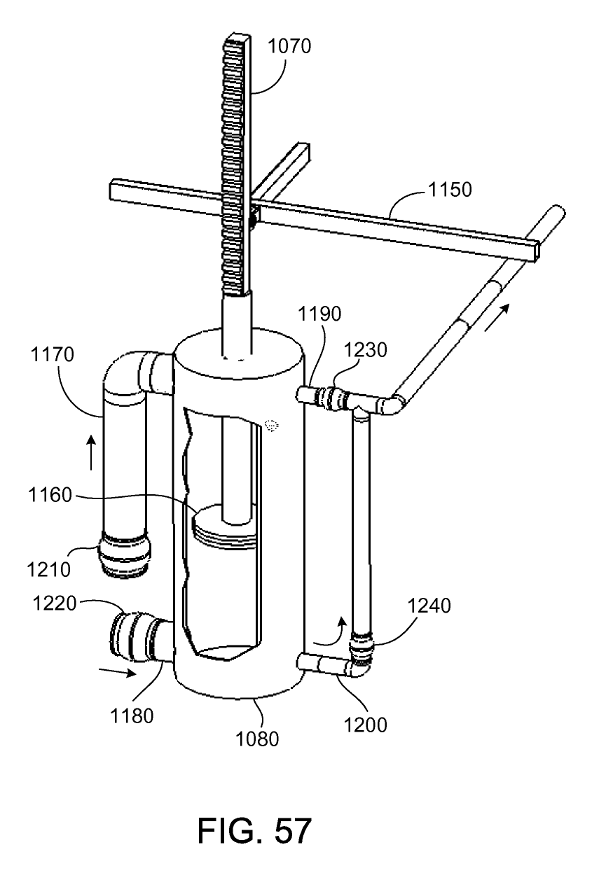

According to certain implementations, the pumping mechanism 20 also includes a brace 1150 located in the chamber 1110 (FIG. 57). In the illustrated implementation, the brace 1150 includes joined orthogonal elements. The brace 1150 may remain in sliding contact with a portion of the rack gear 1070 so that that the rack gear 1070 slides relative to the brace 1150 during a pumping action of the pumping tank 1080, described below. According to one implementation, the brace 1150 contacts the rack gear 1070 in the proximity of where the rack gear 1070 and the pinion gear 1060 engage each other.

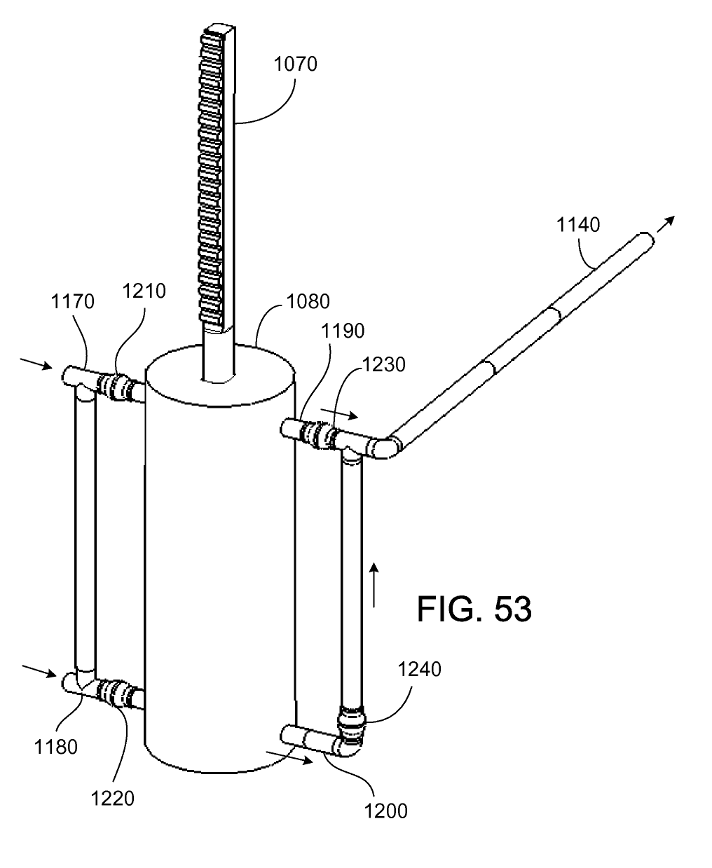

FIGS. 53 and 57 illustrate two alternate implementations of the pumping tank 1080 and the associated piping arrangement. As illustrated in FIG. 57, for example, the rack gear 1070 is coupled to a piston 1160 disposed in an interior of the pumping tank 1080. Further, the piston 1160 and the rack gear 1070 are moveable in the pumping tank 1080, such as in a reciprocal manner. The piston 1160 and the pumping tank 1080 form at least part of a pump of the pumping mechanism operable to pressurize and/or pump the pumping fluid. A first inlet conduit 1170 is attached to a first portion of the pumping tank 1080 and a second inlet conduit 1180 is attached to a second portion of the pumping tank 1080. A first outlet conduit 1190 is attached to the first portion of the pumping tank 1080, and a second outlet conduit 1200 is attached to the second portion of the pumping tank 1080. Both the first and second inlet conduits 1170 and 1180 include one-way (check) valves 1210, 1220 disposed upstream of the pumping tank 1080. Similarly, both the first and second outlet conduits 1190, 1200 include one-way valves 1230, 1240 disposed downstream of the pumping tank 1080. As shown in the implementation of FIG. 53, the first and second inlet conduits 1170, 1180 may be joined upstream of the one-way (check) valves 1230, 1240 by a conduit extending between the inlet conduits 1170, 1180. Alternately, as shown in FIG. 57, the first and second inlet conduits 1170, 1180 may not be joined. Further, as also shown in FIG. 57, an inlet of the first inlet conduit 1170 may be directed away from the tank 1080 (e.g., downwardly). Consequently, the first inlet conduit 1170 may draw in the pumping fluid when a level of the pumping fluid is not proximate the outlet of the first inlet conduit 11170.

According to particular implementations, the first and second outlet conduits 1190, 1200 merge at a location downstream from both one-way valves 1220 and join with the outlet conduit 1140.

According to the implementations illustrated in FIGS. 53 and 57, the pumping tank 1080 has dual-action functionality. That is, the pumping tank 1080 simultaneously intakes and expels a portion of the pumping fluid during both an upward and downward motion of the piston 1160. Alternately, the pumping tank 1080 may have only single-action functionality. That is, the pumping tank 1080 may only intake fluid during one of an upwards or downwards motion of the piston 1160 and may only outlet fluid during the other of the upwards or downwards motion. Accordingly, such an implementation may only require a single inlet conduit and a single outlet conduit. Such inlet and outlet conduits may be attached to the first portion or second portion of the pumping tank 1080. The inlet and outlet conduits in such an implementation may also include respective one-way valves, such as the one-way valves described above.

The pumping mechanism 20 may be disposed in a fluid body at a depth that allows the buoy 50 to float at a surface of the fluid body. In operation, the buoy 50 raises and lowers with an action of the fluid body, such as a wave action. Accordingly, the buoy 50 follows the motion of the surface of the fluid body, causing the buoy 50 to raise and lower relative to the base 1090. Motion of the buoy 50 is translated into a rotational movement as the arm 60 pivots with the shaft 1050. Thus, arm 60 may provide a lever-like action to shaft 1050. As the shaft 1050 rotates, the pinion gear 1060 also rotates, forcing the rack gear 1070 and the piston 1160 to raise and lower within the pumping tank 1080. Thus, when the surface level of the fluid body rises, the buoy 50 also rises, rotating the pinion gear 1060, and driving the piston 1160 downwards. Consequently, fluid in the pumping tank 1080 below the piston 1160 is forced through the second outlet conduit 1200, through the one-way valve 1240, and out through the outlet conduit 1140. The fluid is prevented from traveling through the second inlet conduit 1180 because of the one-way valve 1220. Simultaneously, during the downward movement of the piston 1160, fluid is drawn into the first portion of the pumping tank 1080 above the piston 1160 through the first fluid inlet conduit 1170. Fluid is prevented from being drawn into the pumping tank 1080 from the first outlet conduit 1190 due to the one-way valve 1230.

As the surface of the fluid body lowers, the buoy 50 and arm 60 move downwards. As a result, the pinion gear 1060 causes the rack gear 1070 and piston 1160 to move upwards. As a result, the fluid in the pumping tank 1080 above the piston 1160 is forced out through the first outlet conduit 1190, through the one-way valve 1230, and through the outlet conduit 1140. Fluid is prevented from being forced out of the first inlet conduit 1170 by the one-way valve 1210. Simultaneously, fluid is drawn into a portion of the pumping tank 1080 below the piston 1160 through the second inlet conduit 1180 and the one-way valve 1220. Similarly, fluid is not drawn into the pumping tank 1080 through the second outlet conduit 1200 because of the one-way valve 1240.

Therefore, as a result of the dual action of the pumping mechanism 20, a flow of fluid may be pumped through the outlet conduit 1140. According to one implementation, the fluid pumped by the pumping mechanism 20 may be conveyed and utilized to drive (e.g., turn) a generator to create electricity.

The rack gear 1070 and the piston 1160 remain substantially parallel with the longitudinal axis of the pumping tank 1080 due to the sliding contact between the rack gear 1070 and the brace 1150.

According to one implementation, the pumping mechanism 20 is located in a fluid body, e.g., a large body of water, such that the pumping mechanism 20 is operable both in low tide and high tide conditions. In high tide conditions, the piston 1160 moves upwards and downwards in the second portion of the pumping tank 1080. Conversely, in low tide conditions, the piston 1160 moves upwards and downwards in the first portion of the pumping tank 1080.

In some implementations, the pumping mechanism 20 may also include a bladder coupled to the chamber 1100. The bladder may fill and exhaust a fluid (e.g., air) and prevent the formation of a vacuum within the chamber 1100 when, for example, the buoy 50 experiences a large displacement, causing a corresponding large displacement of the piston 1160 in the pumping tank 1080. Accordingly, the bladder may provide for a more continuous flow of fluid through the pumping tank 1080.

Further, as illustrated in the implementation shown in FIG. 57, the inlet conduits 1170, 1180 may have a larger diameter than the outlet conduits 1190, 1200. The larger diameter conduits reduce the risk of causing cavitation as the fluid is drawn into the pumping tank 1080. Further, the use of larger diameter inlet conduits may prevent the formation of a vacuum within the chamber 1100, thereby eliminating the need for a bladder.

According to a further implementation, the inlet conduit 1130 is coupled directly to the one or more inlet conduits of pumping tank 1180. Consequently, the chamber 1100 does not act as a reservoir for the fluid.

According to one implementation, the inlet conduits 1170, 1180 are six-inch diameter conduits and the one-way valves 1210, 1200, disposed on the inlet conduits 1170, 1180, are six-inch diameter valves. The inlet conduit 1130 also has a six-inch diameter. Further, the piston 1160 has a ten-inch diameter, and the outlet conduits 1190, 1200 and the corresponding one-way valves 1230, 1240 are three inches in diameter. The footprint of the base is two meters by three meters, and the buoy 50 may be sized to displace four tons of water. In general, such a pumping mechanism may be up to one kilometer offshore. The components of the pumping mechanism 20 may, of course, be sized differently depending on the application.

A number of pumping mechanisms may be arranged along a section of coastline. The pumping mechanisms may be situated so that they are actuated at different times. For example, the pumping mechanisms may be arranged at different distances from the shore so that they are actuated at different times by the waves. Also, the pumping mechanisms may be distributed along the coastline to take advantage of variations in wave motion. The pumping mechanisms may be operated collectively such that, for example, the output of the pumping mechanisms is combined and fed to a generator to generate electrical energy. The generator may, for example, be driven by the flow from the pumping mechanisms. The combined outputs of the pumping mechanisms may provide a steady fluid flow to drive the generator and generate electrical power.

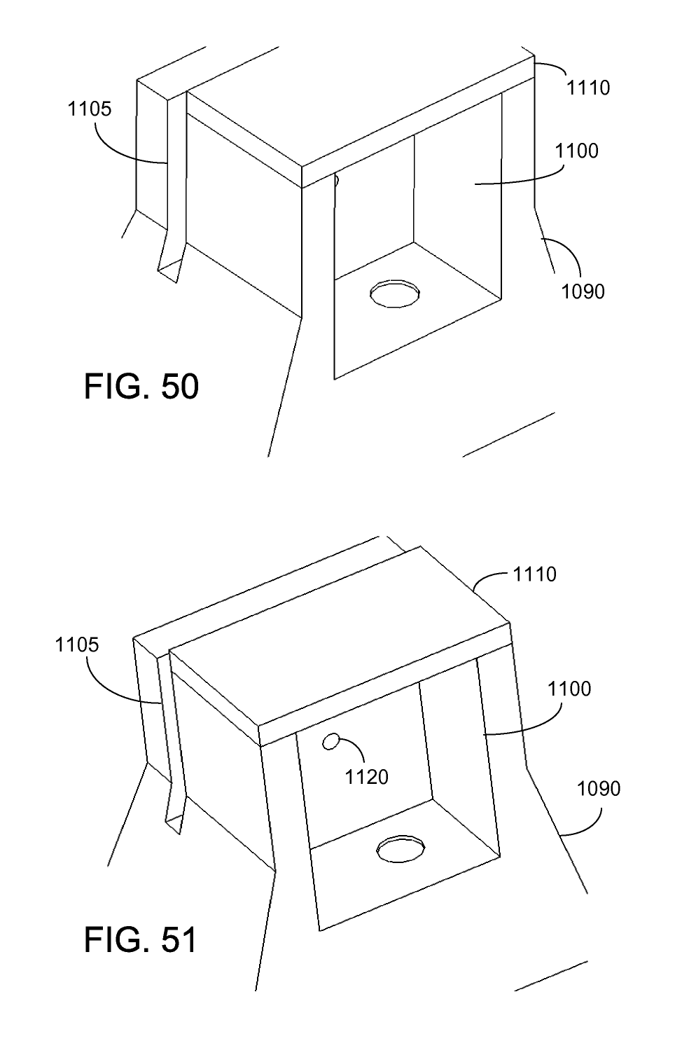

Additionally, the implementation of the pumping mechanism 20 shown in FIGS. 38-57 may be secured to pilings and arranged to convey a pumping fluid to a generator for generating power, for example, as shown in FIG. 1.

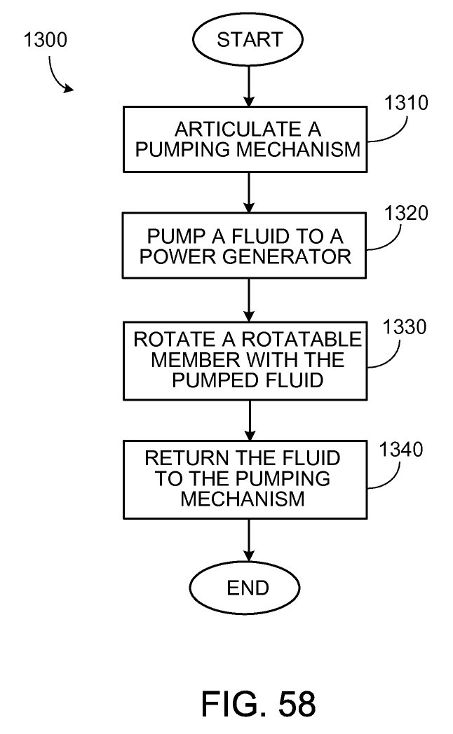

FIG. 58 is a flowchart illustrating a process 1300 for generating power. At 1310, a pumping mechanism is articulated, for example, when a buoyant portion of a pumping mechanism follows a motion of a fluid body. The pumping fluid may, for example, be pressurized by the pumping mechanism. The pumping fluid may be disposed in a reservoir in which the pumping mechanism is also disposed. Consequently, the pumping fluid may also be utilized to provide lubrication to the pumping mechanism in addition to being the fluid utilized for pumping. The pumping mechanism may be, for example, a dual-action pump or a rotary pump actuated by a cam motion of a rotary member. At 1320, the articulation of the pumping mechanism pumps a pumping fluid to a power generator. The power generator may be provided substantially at the same location as the pumping mechanism, such as at an offshore location. Alternatively, the power generator may be located remotely from the pumping mechanism, such as at an onshore location remote from the pumping mechanism. At 1330, the pumped fluid rotates a rotatable member (e.g., a turbine shaft) of the power generator. The rotation of the rotatable member may be converted into electrical power. The rotation may also be utilized directly as mechanical energy or harnessed in some other way to perform useful work. At 1340, the pumping fluid is returned to the pumping mechanism. As explained above, the pumping fluid may be returned to a reservoir in which the pumping mechanism is disposed. Consequently, the pumping fluid is stored for subsequent use, and the pumping mechanism is lubricated by the pumping fluid.

Although FIG. 58 illustrates a process for generating power, other processes may have a variety of other operations and/or arrangements. For example, process 1300 may be repeated in a fairly consistent manner according to the motion of a fluid body. Thus, a power generation system may be repeatedly cycled. Moreover, the operations for a second cycle may begin before the operation for a first cycle are complete. As another example, other processes may include sensing for a problem with the pumping fluid (e.g., contamination or leak). If a problem is sensed, the pumping fluid may be prevented from flowing to the rotatable member. As a further example, a number of pumping mechanisms may be articulated and used to drive a power generator. Additionally, if a problem is sensed with one of the pumping mechanisms, that pumping mechanism may cease supplying pumping fluid while the other pumping mechanisms continue to supply pumping fluid. The pumping mechanism may also cease supplying pumping fluid while the other pumping mechanisms continue to supply pumping fluid in order for the pumping mechanism to be serviced, repaired, or replaced. In certain implementations, the pumping fluid from two or more of the pumping mechanisms may be combined and used to drive a rotatable member. A variety of other operations and/or arrangements exist.

A number of implementations have been described, and several others have been mentioned or suggested. Additionally, various additions, deletions, substitutions, and/or modifications to these implementations will readily be suggested to those skilled in the art while still achieving dynamic fluid energy conversion. Thus, it will be understood that various implementations for dynamic fluid energy conversion may be achieved without departing from the spirit and scope of the disclosure. Moreover, the scope of protectable subject matter should be judged based on the claims, which may encompass one or more aspects of one or more implementations.

What is claimed is:

1. A system for utilizing movements of a fluid body to pressurize a pumping fluid for generating electrical power, the system comprising:
a first pumping mechanism comprising:
a moveable member adapted to follow movements of a fluid body,
a fluid pump coupled to the moveable member and adapted to pressurize a pumping fluid in response to motion of the moveable member, and
a housing, the housing comprising an inner chamber in which the fluid pump resides and from which the fluid pump draws the fluid to be pressurized.

2. The system of claim 1, wherein:
the chamber serves as a reservoir for the pumping fluid; and
the fluid pumping mechanism is at least partially immersed in the pumping fluid.

3. The system claim 1, wherein the moveable member comprises an elongated member and a buoyant member, the buoyant member pivotably coupled to the elongated member proximate an end of the elongated member and adapted to follow fluid body movements, the buoyant member comprising a fin adapted to align the buoyant member with fluid body movements.

4. The system claim 1, further comprising:
a sensor adapted to detect contamination of the pumping fluid; and
a valve system coupled to the sensor, wherein the sensor is adapted to activate the valve system when contamination of the pumping fluid is detected.

5. The system of claim 4, wherein the valve system circulates the pressurized pumping fluid to the chamber when activated.

6. The system of claim 1, wherein the fluid pump comprises:
a tank having a moveable piston housed therein;
at least one fluid inlet conduit coupled to the tank;
a first one-way valve attached to the at least one fluid inlet conduit;
at least one fluid outlet conduit coupled to the pumping tank; and
a second one-way valve attached to the at least one fluid outlet conduit.

7. The system claim 1, further comprising a power transmission mechanism adapted to convey power from the moveable member to the fluid pump.

8. The system of claim 7, wherein the power transmission mechanism comprises a pivoting mechanism coupled between the moveable member and the fluid pump.

9. The system of claim 8, wherein the power transmission mechanism comprises a pinion gear coupled to the pivoting mechanism and a rack gear coupled to the fluid pumping mechanism, wherein the pinion gear and the rack gear engage each other.

10. The system claim 1, wherein the fluid pump comprises:
a plurality of pumping cylinders adapted to pump the pumping fluid; and
a rotatable cam adapted to drive the cylinders in response to the moveable member following fluid body movements.

11. The system of claim 10, wherein the pumping cylinders form a plurality of axial rows arranged radially circumjacent to the cam, the cam being rotatable relative to the plurality of pumping cylinders and inward-facing ends of the cylinders adapted to follow the outer surface of the cam;
at least one first check valve provided upstream of inlets of the pumping cylinders; and
at least one second check valve provided downstream of outlets of the pumping cylinders, wherein a first axial row of pumping cylinders is adapted to intake a volume of pumping fluid while a second axial rows of pumping cylinders is adapted to simultaneously expel a volume of pumping fluid as the cam rotates.

12. The system of claim 1, further comprising a second pumping mechanism, the second pumping mechanism comprising:
a moveable member adapted to follow movements of a fluid body,
a fluid pump coupled to the moveable member and adapted to pressurize a pumping fluid in response to motion of the moveable member, and
a housing, the housing including an inner chamber in which the fluid pumping mechanism resides and from which the fluid pumping mechanism draws the fluid to be pressurized.

13. The system of claim 12, further comprising a conduit system for combining the pressurized pumping fluid from the first pumping mechanism and the second pumping mechanism.

14. The system of claim 12, wherein the second pumping mechanism may cease supplying pressurized pumping fluid while the first pumping mechanism continues to supply pressurized pumping fluid.

15. The system of claim 14, wherein the second pumping mechanism may be replaced while the first pumping mechanism continues to supply pressurized pumping fluid.

16. A system for utilizing movements of a fluid body to pressurize a pumping fluid for generating electrical power, the system comprising:
a first pumping mechanism positioned in a fluid body, the pumping mechanism comprising:
a moveable member adapted to follow movements of the fluid body,
a fluid pump coupled to the moveable member and adapted to pressurize a pumping fluid in response to motion of the moveable member, and
a housing, the housing comprising an inner chamber enclosing the fluid pump and including a fluid outlet for conveying the pressurized pumping fluid and a fluid inlet for receiving the pumping fluid;
a rotatable member positioned on a shore of the fluid body and coupled to a first conduit system that conveys the pressurized pumping fluid from the first pumping mechanism and a second conduit system that conveys the pumping fluid back to the first pumping mechanism; and
a power generator coupled to, and driven by, the rotatable member.

17. The system of claim 16, wherein:
the chamber acts as a reservoir for the pumping fluid; and
the fluid pump is at least partially immersed in the pumping fluid.

18. The system claim 16, further comprising:
a sensor adapted to detect contamination of the pumping fluid; and
a valve system coupled to the sensor, the valve system adapted to circulate the pressurized pumping fluid to the chamber when activated by the sensor detecting contamination in the pumping fluid.

19. The system claim 16, wherein the fluid pump comprises:
a plurality of pumping cylinders adapted to pump the pumping fluid; and
a rotatable cam adapted to drive the cylinders in response to the moveable member following fluid body movements.

20. The system of claim 16, further comprising a second pumping mechanism, the second pumping mechanism positioned in the fluid body and comprising:
a moveable member adapted to follow movements of the fluid body,
a fluid pump coupled to the moveable member and adapted to pressurize a pumping fluid in response to motion of the moveable member, and
a housing, the housing comprising an inner chamber enclosing the fluid pump and including a fluid outlet for conveying the pressurized pumping fluid and a fluid inlet for receiving the pumping fluid.

21. The system of claim 20, wherein the first conduit system combines the pressurized pumping fluid from the first pumping mechanism and the second pumping mechanism for driving the rotatable member.

22. The system of claim 20, wherein the second pumping mechanism may cease pumping pressurized pumping fluid while the first pumping mechanism continues to supply the pressurized pumping fluid.

23. The system of claim 22, wherein the second pumping mechanism may be replaced while the first pumping mechanism continues to supply the pressurized pumping fluid.

24. The system of claim 16, further comprising:
a bypass conduit in communication with the first conduit system and the second conduit system; and
a bypass valve coupled to the bypass conduit, the bypass valve adapted to allow flow of the pressurized pumping fluid between the first and second conduit systems when a predetermined pressure of the pumping fluid is detected.

25. A system for utilizing movements of a fluid body to pressurize a fluid for generating electrical power, the system comprising:
a number of pumping mechanisms positioned in a fluid body and at various distances from a shore of the fluid body, each pumping mechanism comprising:
a moveable member comprising an elongated member and a buoyant member, the buoyant member pivotably coupled to the elongated member proximate an end of the elongated member and adapted to follow movements of the fluid body, the buoyant member including a fin adapted to align the buoyant member with the fluid body movements,
a fluid pump coupled to the moveable member and adapted to pressurize a pumping fluid in response to motion of the moveable member,
a power transmission mechanism adapted to convey power from the moveable member to the pumping mechanism,
a housing comprising an inner chamber that serves as a reservoir from which the fluid pump draws the pumping fluid to be pressurized and encloses the fluid pump, the fluid pump at least partially immersed in the pumping fluid, the housing including a fluid outlet for conveying the pressurized pumping fluid and a fluid inlet for receiving the pumping fluid,
a sensor adapted to detect contamination of the pumping fluid, and
a valve system coupled to the sensor, the valve system adapted to circulate the pressurized pumping fluid to the chamber when activated by the sensor detecting contamination in the pumping fluid;
a rotatable member positioned on the shore of the fluid body and coupled to a first conduit system that conveys the pressurized pumping fluid from the pumping mechanisms and a second conduit system that conveys the pumping fluid back to the pumping mechanisms, wherein at least one of the pumping mechanisms may be shut-down and replaced while the other pumping stations continue to supply pressurized pumping fluid;
a bypass conduit coupled between the first and second conduit systems;
a bypass valve coupled to the bypass conduit, the bypass valve adapted to allow flow of the pressurized pumping fluid between the first and second conduit systems when a predetermined pressure of the pumping fluid is detected; and
a power generator coupled to, and driven by, the rotatable member.

26. A method for utilizing movements of a fluid body to pressurize a fluid for generating electrical power, the method comprising:
pressurizing a pumping fluid in a reservoir in response to movements of a fluid body;
conveying the pressurized pumping fluid to a rotatable member for a power generator located on a shore of the fluid body; and
conveying the pumping fluid to the reservoir.

27. The method of claim 26, wherein the reservoir contains a pumping mechanism.

28. The method of claim 27, wherein the pumping mechanism is at least partially immersed in the pumping fluid in the reservoir.

29. The method of claim 26, wherein pressurizing a pumping fluid comprises:
following movements of the fluid body with a moveable element adapted to follow movements of a fluid body; and
articulating a pumping mechanism coupled to the moveable element.

30. The method of claim 29, further conveying power from the moveable element to the fluid pump.

31. The method of claim 26, further comprising:
sensing for contamination of the pumping fluid; and
activating a valve system if contamination of the pumping fluid is detected.

32. The method of claim 31, wherein the valve system circulates the pressurized pumping fluid to the reservoir when activated.

33. The method of claim 26, wherein pressurizing a pumping fluid in a reservoir in response to movements of a fluid body comprises:
drawing the pumping fluid into a fluid inlet of a tank, the fluid inlet having a first one-way valve;
moving a piston housed in the tank to pressurize the pumping fluid; and
expelling the pressurized pumping fluid through a fluid outlet having a second one-way valve.

34. The method of claim 26, wherein pressurizing a pumping fluid in a reservoir in response to movements of a fluid body comprises driving a rotatable cam having a plurality of pumping cylinders around its radial periphery.

35. The method of claim 26, further comprising:
pressurizing a second pumping fluid in a second reservoir in response to movements of the fluid body;
conveying the pressurized second pumping fluid to a second rotatable member; and
conveying the second pumping fluid to the second reservoir.

36. The method of claim 35, further comprising combining the pressurized first pumping fluid and the pressurized second pumping fluid prior to conveying the pressurized first pumping fluid and the pressurized second pumping fluid to the rotatable member, wherein the first rotatable member and the second rotatable member are the same.

37. The method of claim 36, wherein conveying the pumping fluid to the reservoir comprises conveying at least part of the first pumping fluid to the first reservoir.

38. The method of claim 35, further comprising ceasing to convey the pressurized second pumping fluid while continuing to convey the pressurized first pumping fluid.

39. The method of claim 35, further comprising replacing a second pumping mechanism supplying the pressurized second pumping fluid while a first pumping mechanism supplying the pressurized first pumping fluid continues to supply the pressurized first pumping fluid.
